(19) United States
(12) Patent Application Publication
(10) Pub. No.: US 2026/0157897 A1
(43) Pub. Date: Jun. 11, 2026

(54) A WHEEL ASSEMBLY FOR A MANUAL WHEELCHAIR

(71) Applicants: Rory Christian Flemmer, Palmerston North (NZ); Claire Lorriane Flemmer, Palmerston North (NZ)

(72) Inventors: Rory Christian Flemmer, Palmerston North (NZ); Claire Lorraine Flemmer, Palmerston North (NZ)

(21) Appl. No.: 19/124,022

(22) PCT Filed: Oct. 25, 2023
(86) PCT No.: PCT/NZ2023/050113

§ 371 Date: Apr. 24, 2025

(30) Foreign Application Priority Data
Oct. 26, 2022 (NZ) 793757

(51) Int. Cl. A61G 5/04; A61G 5/10

(52) U.S. Cl. CPC A61G 5/041; A61G 5/1027

(57) ABSTRACT

Manual wheelchairs are generally propelled by rotation of a pushrim or handrail, forward or backwards. The propulsive effort is inefficient, impulsive, repetitive, and damaging to muscles and connective tissue. A wheel assembly, disclosed here, has a pushrim as well as a folding handle. The wheel assembly can operate in a first or standard mode with the handle furled, where the pushrim is functionally connected to a road wheel such that the wheel turns forward or backward, as the pushrim turns forward or backward. A second mode is provided where the handle is deployed and the road wheel turns strictly forwards, when the pushrim or handle is moved either forward or backwards. This mode is selected when the handle is unfurled and latched. Three selectable gear ratios as well as braking and anti-rollback protection are provided.

### TECHNICAL FIELD

The invention relates to a wheel assembly for a wheelchair that allows propulsion of the chair in two different modes of operation. The invention also relates to a wheelchair comprising such a wheel assembly

### BACKGROUND OF THE INVENTION

Known manually powered wheelchairs typically comprise a wheel that rotates about an axle, and a pushrim, operably connected to the wheel, that rotates about the axle simultaneously and in the same direction as the wheel. In this way, it is possible to manually propel the wheel by pushing or pulling the top of the pushrim in the desired direction of travel. It is therefore common for existing manually powered wheelchairs (MWC) to be propelled by grasping the pushrim and pushing it forward, releasing the grasp, moving the hand back to re-grip the pushrim and then repeating the process. The effort involved in propelling a wheelchair in this manner is inefficient and can lead to repetitive strain injury.

A wheelchair that does not require repetitive grasping and could offer a more efficient mode of propulsion would be beneficial.

### SUMMARY OF INVENTION

In a first aspect, the present invention provides a wheel assembly for a wheelchair, the wheel assembly comprising: a wheel rotatably mounted on a main shaft, a drive assembly, and a control member configured to rotate around the main shaft, the radius of rotation of the control member being within the radius of the wheel, the control member being operably engaged with the wheel via the drive assembly to propel the wheelchair, wherein the control member comprises a control element which can be furled or unfurled, such furling or unfurling changing the operation of the wheel chair between two modes of operation: a first mode, wherein the wheel always rotates in the same direction that the control member is rotated; and a second mode, wherein rotation of the control member in a first direction or in an opposite direction is translated into rotation of the wheelchair in a single direction.

In an embodiment, unfurling the control element changes the mode of operation of the wheelchair to the second mode.

In an embodiment, furling the control element configures the control element such that the axis of the control element lies in a plane that is functionally orthogonal to the axis of rotation of the wheel assembly.

In an embodiment, the control element can be unfurled to protrude from the plane of the rotation of the control member, such that the axis of the control element is substantially parallel to the main shaft and can be grasped by a user.

In an embodiment, the control element can be locked in the unfurled position.

In an embodiment, the control member is a pushrim.

In an embodiment, the wheel assembly comprises means to limit the rotation of the control member when the wheel assembly is in the second mode, such that the control element remains substantially within an upper half of the wheel assembly but will be able to move from a lower half to the upper half, where the control element becomes trapped, thereby providing that the handle will never fall out of the reach of a user.

In an embodiment, the main shaft comprises a spigot attached axially and concentrically, to engage the wheel assembly with a hole in a frame of the wheelchair.

In an embodiment, the wheel assembly further comprising wedges, positioned between rotary cam followers and brake drums that are rotatably mounted on the main shaft, the wedges being drawn into a pinch point between the cam followers and the brake drums by springs acting between the wedges and a structure supporting the cam follower and being configured to lock rotation between the cam follower and the brake drum, when rotated in one direction and to slide when rotated in the other direction.

In an embodiment, the wedges comprise curved inner surfaces to substantially conform to a curved outer edge of the brake drum.

In an embodiment, the wheel assembly further comprising mechanical or electrical means that engage with the wedge to withdraw the wedge away from the pinch point between brake drum and the cam follower and thereby to disable interaction between cam follower and brake drum.

In an embodiment, a Vee'ed cam follower engages with a ridge on the wedge to restrain lateral movement of the wedge.

In an embodiment, the wheel assembly comprises a first brake drum and a second brake drum, the brake drums rotatably mounted on the main shaft and configured to be rotationally impelled by wedges that can be induced to jam in pinch points between the cam followers and the brake drums.

In an embodiment, the wheel assembly comprises a contra-rotation mechanism that causes any rotation of the first brake drum in any direction to cause rotation of the second brake drum in the contrary direction and any rotation of the second brake drum in any direction to cause rotation of the first brake drum in a contrary direction.

In an embodiment, the contra-rotation mechanism comprises two roller chains and a plurality of roller chain sprockets that are interposed between the first and second brake drums.

In an embodiment, the wheel assembly comprises an epicyclic gearbox comprising a sun gear, a plurality of planet gears and a ring gear, the gearbox being positioned concentrically about the main shaft and being slidable on the main shaft such that the rotation of the control member can be transmitted to the wheel at a plurality of gear ratios.

In an embodiment, crossed keys are inserted diametrically and slidably into slots in the main shaft, to extend on either side of the main shaft and to engage in slots in the inner surface of the sun gear, each key having protrusions so that, when the crossed keys are nested the protrusions will press on either side of the sun gear.

In an embodiment, the crossed keys are securely attached to a member, in a preferred arrangement, a first cylinder that is a sliding fit in the main shaft, the assemblage ensuring that the sun gear can move irrotationally along the axis of the main shaft but is at all times substantially orthogonal to the main shaft.

In an embodiment, the wheel assembly comprises a second cylinder that is concentric with the first cylinder and slides in the main shaft on the side of the first cylinder away from the spigot and that can be drawn away from the first cylinder against a first spring within the first cylinder, can rotate freely with respect to the first cylinder but cannot be moved closer to the first cylinder than its quiescent position where it is almost touching the first cylinder, the second cylinder offering an anchor point to attach one or a plurality of fine wire ropes to it.

In an embodiment, the wheel assembly comprises a second compression spring, acting against the second cylinder, the spring tending to push the second cylinder and thus the first cylinder, the crossed keys and the epicyclic gearbox towards the spigot.

In an embodiment, pulleys are provided to lead one or a plurality of fine wire ropes from a mooring point on the second cylinder via a hawsepipe and thence to a remote mechanism whose function is to pull the rope or ropes, against the second compression spring, to one definite, detented, position selected from a plurality of such selectable positions, each position corresponding to a definite station of the gearbox on the main shaft and consequently a selected gear ratio.

In an embodiment, a wheel hub is rotationally mounted to the end of the main shaft closest to the spigot, a plurality of spokes extending radially from this hub to the rim of a road wheel and wherein a driven dog clutch is concentrically affixed to the hub, on the side of the hub remote from the spigot, the driven dog clutch engaging with dog clutches associated with the epicyclic gearbox and being driven by the epicyclic gearbox.

In an embodiment, the wheel assembly comprises a structure, termed an “oscillator” that can rotate or oscillate about the main shaft, comprising a first circular plate and a second circular plate, separated by rigid separation members, and bolted together so that it forms a rigid structure.

In an embodiment, one or both of the brake drums has a concentric bevel that can mate with a Vee'ed cam follower, rotatably attached to the first or second plate, thus providing axial and radial location of the oscillator on the main shaft.

In an embodiment, the cam followers that serve to force the wedges against the brake drums, are rotatably mounted to the rigid separation members associated with the oscillator so that, when a wedge, either on the first or second brake drum jams, the rotation of the oscillator will transmit a torque to this brake drum.

In an embodiment, friction wedges operate on the second brake drum in such a way that rotation of the oscillator in the direction contrary to forward motion of the wheels jams the wedges and impels torque transfer from the oscillator to the second brake drum and allows free rotation in the opposite direction.

In a second aspect, the present invention provides a wheelchair comprising the wheel assembly.

### BRIEF DESCRIPTION OF THE DRAWINGS

FIG. 1 is an isometric rear view of one form of wheel assembly for a wheelchair that comprises a wheel and a drive assembly;

FIG. 2 is a right, rear isometric view of the wheel assembly of FIG. 1 and in which the control element is in a first disposition;

FIG. 3 is a right rear, front isometric view of the wheel assembly of FIG. 1 and in which the control element is in a second disposition;

FIG. 4 is an isometric view of the drive assembly/propulsive element in which the control element is in the second disposition;

FIG. 5a is a cross-sectional isometric view through a central portion of the wheel assembly;

FIG. 5b is a cross-sectional isometric view through a central portion of the wheel assembly, showing an epicyclic gearbox;

FIG. 6 is an isometric view of one form of epicyclic gearbox that may be used with the drive assembly;

FIG. 7 is a partial isometric view of the epicyclic gearbox of FIG. 6 and in which, the first outer dog clutch and the adjacent washer have been removed for clarity;

FIG. 8 is a cross-sectional isometric view through a portion of the epicyclic gearbox of FIGS. 6 and 7;

FIGS. 9a and 9b are cross-sectional views through the epicyclic gearbox of FIGS. 6-8, which is positioned on the main shaft and in which the outer dog clutches are in a configuration corresponding to the middle gear ratio;

FIGS. 10a and 10b are cross-sectional views through the epicyclic gearbox of FIGS. 6-8, which is positioned on the main shaft and in which the outer dog clutches are in a configuration corresponding to the lowest gear ratio;

FIGS. 11a and 11b are cross-sectional views through the epicyclic gearbox of FIGS. 6-8, which is positioned on the main shaft and in which the outer dog clutches are in a configuration corresponding to the highest gear ratio;

FIG. 12a is a right, rear isometric view of the wheel assembly with various elements removed to show the oscillator structure;

FIG. 12b is a left, rear isometric view of the wheel assembly with various elements removed to show the oscillator structure;

FIG. 12c is a right, front isometric sectional view of the wheel assembly with various elements removed to show the oscillator structure;

FIG. 13 is a schematic isometric view of a preferred form of wedge cam follower and friction wedge arrangement;

FIG. 14a is an isometric sectional view showing a plurality of mode one locking arms with cables and friction wedges removed for clarity;

FIG. 14b is a schematic showing a mode one locking arm;

FIG. 14c is an isometric view of the oscillator, showing a plurality of mode one locking arms and a plurality of friction wedges, operating on the bevel brake drum, with cables removed for clarity;

FIG. 15 is an isometric view showing friction wedges on the first and second plates of the oscillator structure;

FIG. 16a is an isometric view of a chain assembly showing a side furthest from the spigot;

FIG. 16b is an isometric view of the chain assembly showing a side nearest the spigot;

FIG. 17a is an isometric view of one form of the arrangement that secures the sun gear;

FIG. 17b is another isometric view of the arrangement of crossed keys, first cylinder and sun gear;

FIG. 17c is an isometric view showing the crossed keys and the main shaft;

FIG. 17d is a sectional view of the first and second cylinders and associated members;

FIG. 18a is an isometric view of the structures within the control column that are associated with setting the gear ratio of the wheel assembly;

FIG. 18b is an isometric view of the structures within the control column that are associated with setting the gear ratio of the wheel assembly;

FIG. 19a is an isometric view of a portion of the interior of one form of control element in a furled disposition;

FIG. 19b is an isometric inward facing view of a portion of one form of control element showing a spring that acts upon the mode change drum;

FIG. 19c is an isometric view of a portion of the interior of one form of control element in a furled disposition;

FIG. 19d is an isometric view of the mode change drum, with attached cables;

FIG. 20 is an isometric view of the control column with the control element in the deployed disposition;

FIG. 21 is an isometric view of one form of the control column, showing the mechanism for unlatching the control element;

FIG. 22 is an isometric view from the right rear showing one form of the control column;

FIG. 23 is an isometric view from the right rear showing one form of the control column and a brake capstan and Bowden cable;

FIG. 24 is an isometric view of a portion of the wheel assembly, with certain parts removed, to show one arrangement of a braking system;

FIG. 25 is an isometric view that demonstrates operation of one form of snubbing mechanism that may be used with the wheel assembly of the invention; and

FIG. 26 is a partial isometric view showing further detail of the snubbing mechanism of FIG. 25.

### DETAILED DESCRIPTION

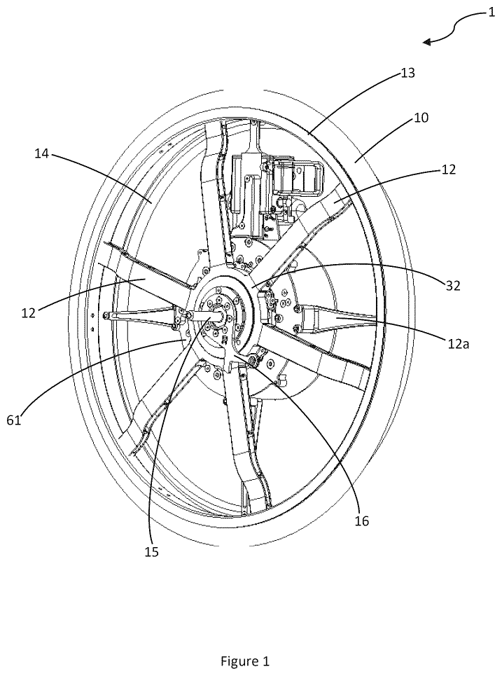

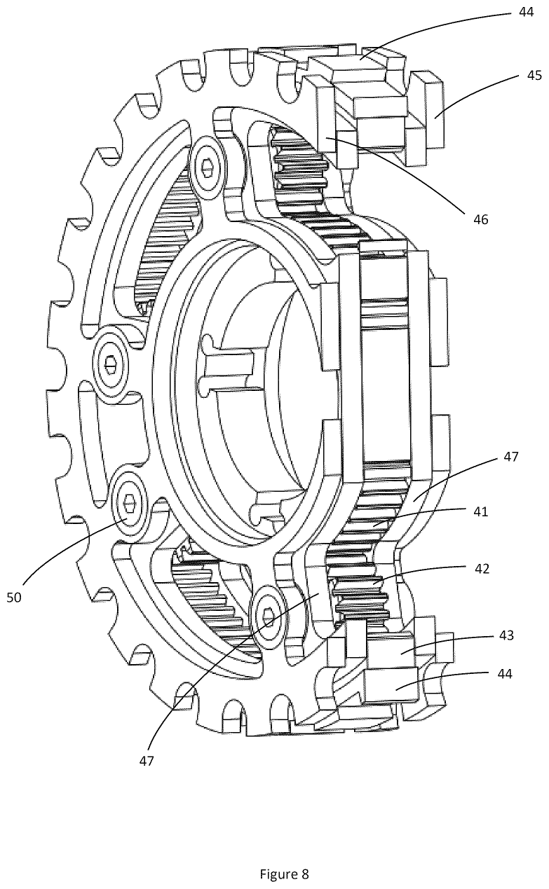

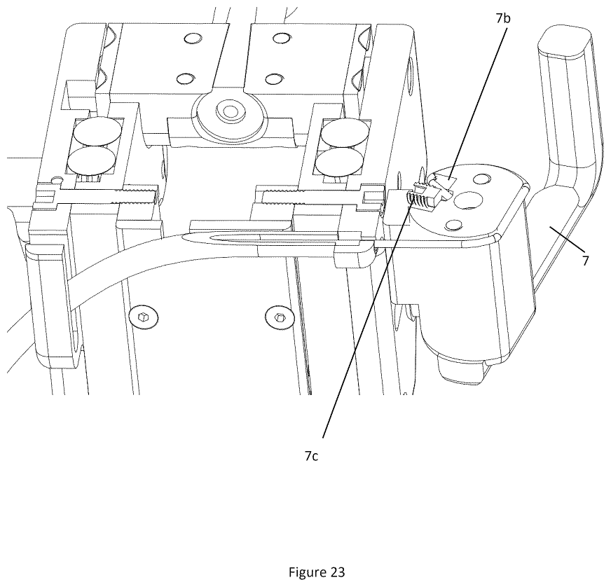

The present invention relates to a wheel assembly for a wheelchair and to a wheelchair comprising such a wheel assembly. FIGS. 1-26 illustrate preferred embodiments of the wheel assembly and its various components. The wheel assembly is configured to allow the wheelchair to be propelled in two different modes of operation: a first mode, and a second mode.

The wheel assembly comprises a wheel that rotates about a main shaft and a control member, such as a pushrim, that also rotates about the main shaft. The pushrim is operably connected to the wheel via an oscillator. A control element comprising a gripping portion, such as a handle, is operationally attached to the pushrim for grasping by a user of the wheelchair if the user prefers not to grasp the pushrim.

In the first mode, motion of a pushrim is not rectified so that pushing the pushrim forward at the top of its extent or pulling the pushrim backward at the top of its extent causes the wheel to simultaneously rotate in the same forward or backward directions, causing the wheelchair to advance or retire respectively. This arrangement follows the standard propulsion approach used by many manually driven wheelchairs.

In the second mode, the pushrim can be rotated without directional coupling to the wheel. A drive system, comprising a drive assembly and an oscillator is operably connected with the pushrim and the wheel assembly to cause forward propulsion of the wheel upon movement of the pushrim in any direction and to also cause forward propulsion of the wheel upon movement of the pushrim in the opposite direction. In this second mode, the wheel assembly does not rotate backwards. This serves as anti-rollback protection, which is desirable when climbing a hill or ramp.

In effect, when the wheel assembly is in the second mode of operation, motion of the control member is rectified. In this manner, an occupant/user of the wheelchair can push and pull the control member forward and back at the top of its extent and with each pushing and pulling movement, the wheel is caused to rotate forward, propelling the wheelchair forward and allowing for a more efficient drive. In some forms, the drive assembly comprises a gearbox that allows the occupant of the chair to select from a plurality of gears in order to further enhance the efficiency of the drive.

A preferred embodiment of a wheel assembly is shown in FIGS. 1, 2 and 3.

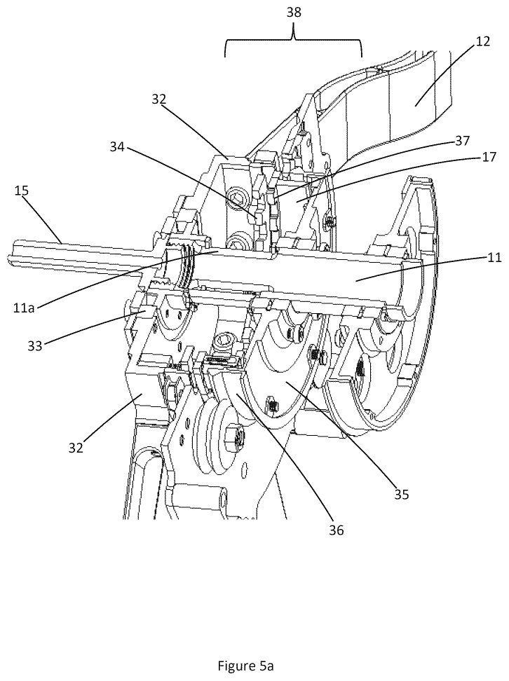

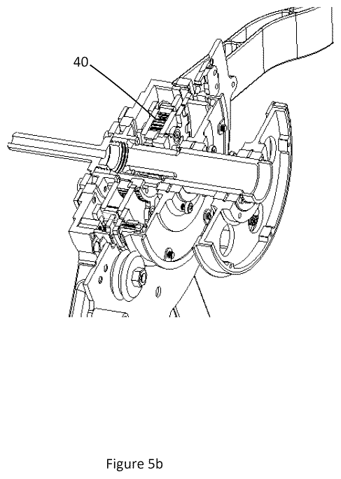

As shown in FIGS. 1 and 5, the wheel assembly 1 is attachable to a frame of a wheelchair via a spigot 15 that projects from a main shaft 11 of the wheel assembly. The wheel assembly 1 comprises a wheel 10 that rotates around the main shaft 11 (at a fixed axial station). The wheel is mounted on a wheel hub 32 of a drive assembly that is rotationally mounted on the main shaft 11. In preferred forms, the wheel hub 32 is rotatably mounted to the main shaft 11 via a ball bearing 33. Preferably, a single, large slender ball bearing 33 is used to reduce the axial dimension of the drive assembly. Such a bearing is calculated to be capable of sustaining the moment on the spigot 15.

A plurality of spokes 12 extend radially from the wheel hub 32 and connect with a wheel rim 13 that supports a tyre. The wheel assembly further comprises a pushrim 14 (also known as a hand rim) that is a generally circular element that rotates around the central main shaft 11. The pushrim 14 is rotatable about the main shaft 11 and preferably lies in a plane that is substantially parallel to that of the wheel rim 13. Therefore, both the wheel 10 and the pushrim 14 are rotatable about the main shaft 11.

The wheel assembly 1 may be attached to the frame of a wheelchair by any suitable arrangement. In some forms, the spigot 15 is configured to be received within an aperture of the wheelchair frame. For example, the spigot 15 may be slid into a round hole, which is a feature of standard wheelchair frames, and secured in place using known forms of attachment or any other suitable attachment. The attachment of the wheel assembly is configured to ensure that the main shaft 11 does not rotate, but that the wheel 10 rotates about the main shaft 11. Therefore, the wheel assembly 1 can be readily attached to and removed from a standard wheelchair frame using known methods. An attachment bracket 16 may be provided to rigidly fix the main shaft to the wheelchair frame, such that the shaft can neither rotate nor move laterally along the shaft. This bracket engages with a structure (not shown) that is attached to the frame and, when the bracket and the structure are engaged, the main shaft cannot rotate.

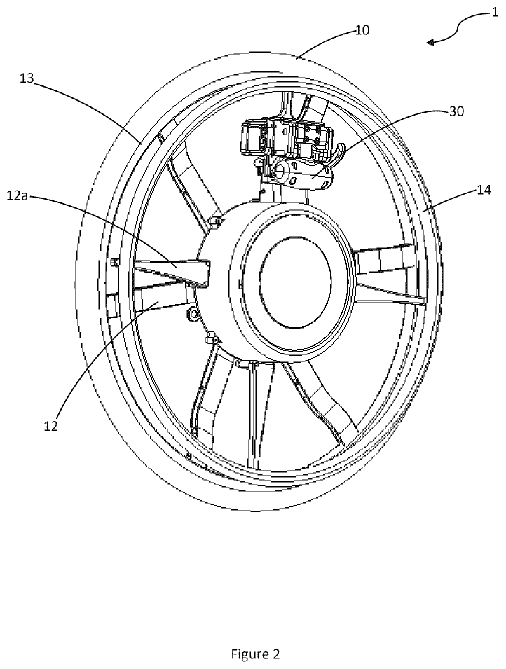

The wheel assembly 1 further comprises a control element 30 comprising a grasping portion, such as a handle, to be grasped by a user of the wheelchair. The control element 30 may be any feature that is connectable to the wheel assembly 1 and the drive assembly and that is capable of being gripped, pushed, pulled, or manoeuvred by an occupant/user of the wheelchair to cause rotation of the pushrim 14. In some forms, the control element 30 comprises a handle or a lever. In a preferred form, as shown in FIGS. 2, 3 and 4, the control element 30 comprises an ergonomically designed handle. The control element 30 operably engages with a control column 91, and the drive assembly.

In some realisations of the invention, the control element 30 is moveable between a first disposition and a second disposition and is so configured that such a movement causes the wheel assembly 1 of the invention to alternate between a first operating mode and a second operating mode. In effect, the first and second operating modes are selectable by changing the disposition/orientation of the control element 30.

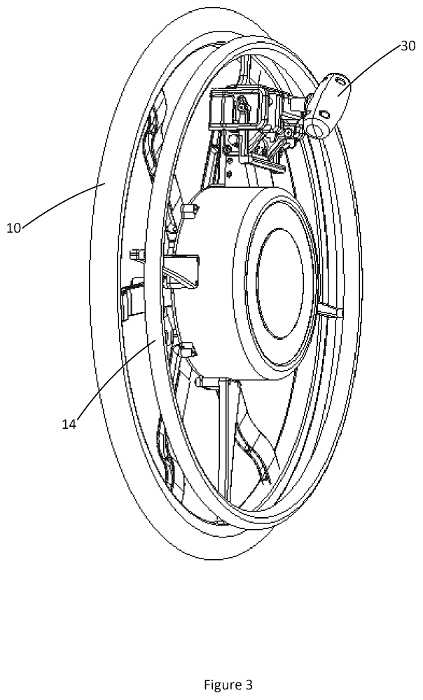

For example, as shown in FIGS. 2 and 3, the control element 30 is selectively moveable between a first disposition, in which the control element 30 adopts the first mode of operation, and a second disposition, in which the control element 30 adopts the second mode of operation. In the first disposition, the control element 30 is proximate the wheel 10, as shown in FIG. 2. The first disposition may be considered to be a stowed or furled position. In some forms, as shown in FIG. 2, at least a portion of the control element 30 lies substantially within the plane of the pushrim 14 when the control element 30 is in the first disposition. In this way, the overall width of the wheelchair is reduced.

In the first disposition, the control element 30 engages with the control column 91 and the drive assembly in a manner that causes the wheel assembly I to operate in the first mode, in which the wheelchair is operated in substantially the same manner as a standard manually powered wheelchair, i.e. pushing the pushrim 14 forward at the top of its extent creates simultaneous forward propulsion of the wheel 10, causing the wheelchair to advance/move forward. Whereas pulling the pushrim 14 backwards at the top of its extent creates simultaneous rearward propulsion of the wheel 10, causing the wheelchair to retire/reverse.

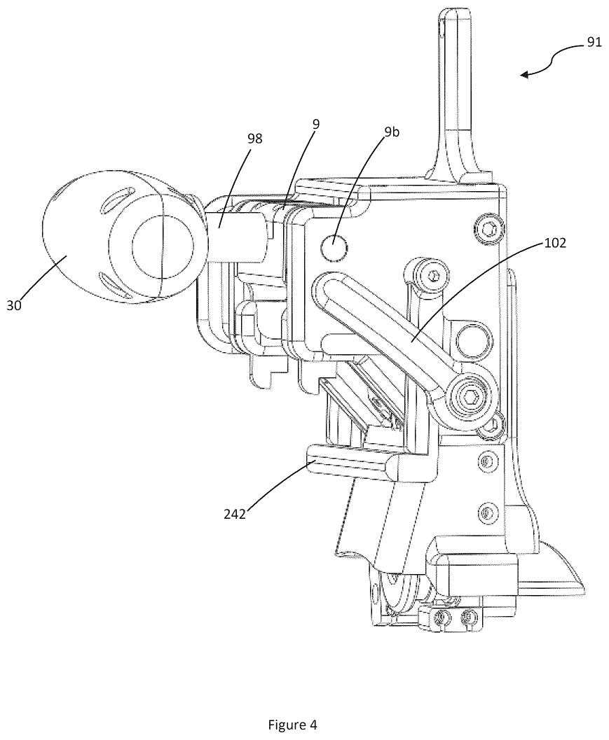

As shown in FIG. 4, in some configurations, the control element 30 is rotatably mounted on a stub shaft 98. This is fixedly attached to a mounting block 9 that can rotate within the control column 91, pivoting on trunnion pins 9b. The pins permit the member and the control element to adopt a second disposition where the stub shaft is essentially horizontal in FIG. 4. Or alternatively, adopt a first position, where the stub axle is essentially vertical in FIG. 4.

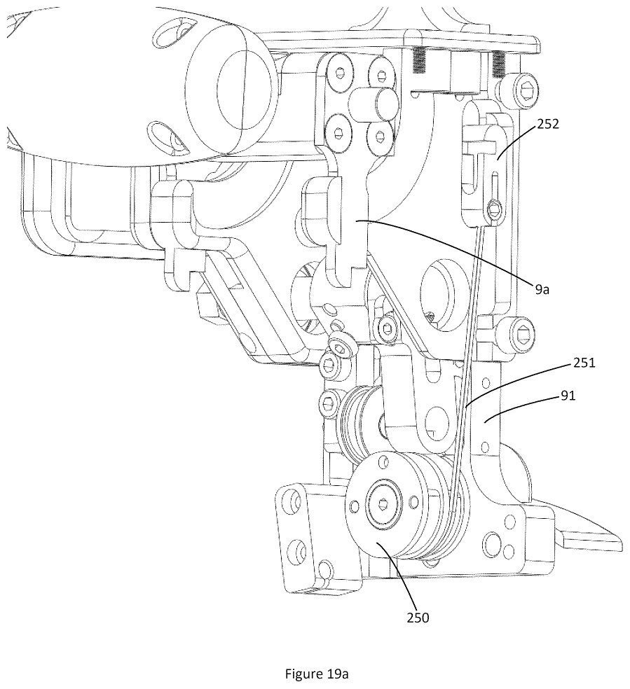

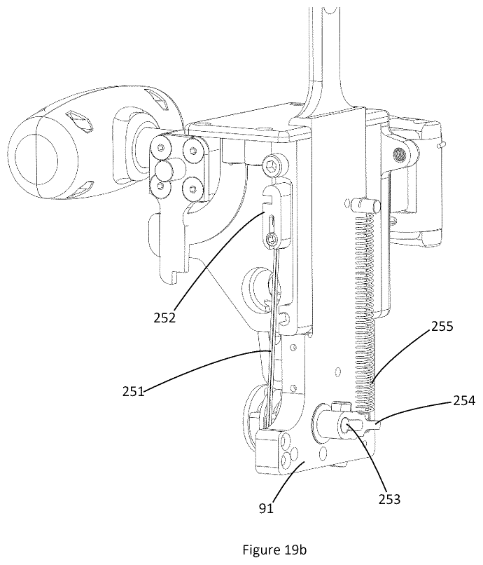

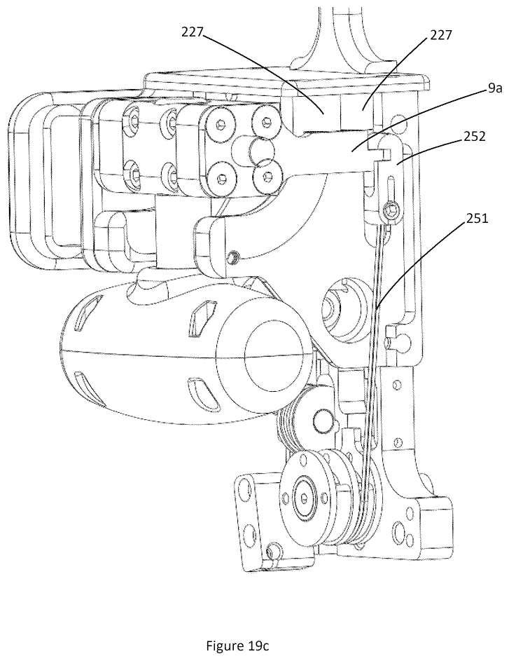

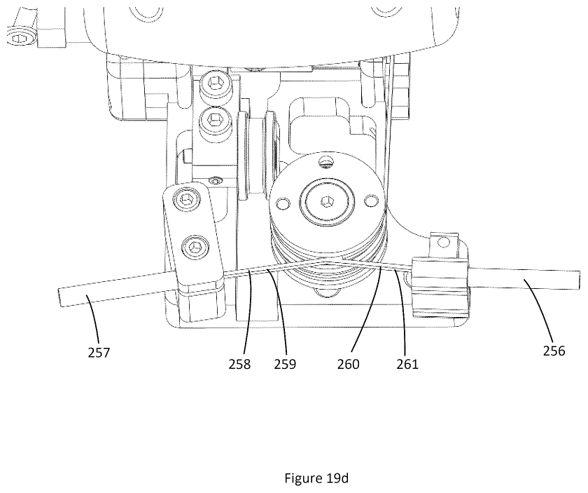

In some forms, the control element 30 may be retained in the first disposition by the arms 9a of the mounting block locking against a magnet 227 located on the control column 91, as shown in FIG. 19c. An arm 9a of the mounting block and a magnet 227 are preferably symmetrically disposed on both sides of the mounting block 9. The magnet(s) has/have sufficient force to hold the control element 30 in the first position, but is/are weak enough to allow a user to overcome the magnetic force by moving the control column to the second position.

When the control element 30 is in the second disposition, as shown in FIG. 3, the control element 30 engages with the drive assembly in a manner that causes the wheel assembly 1 to operate in the second mode. In the second mode, movement of the control element 30 or pushrim 14 in a first direction or in a second direction (such as in the forward and backward directions) propels the wheelchair in a single direction (such as the forward direction), braking is possible, and (optionally) any one of a plurality of gears can be selected.

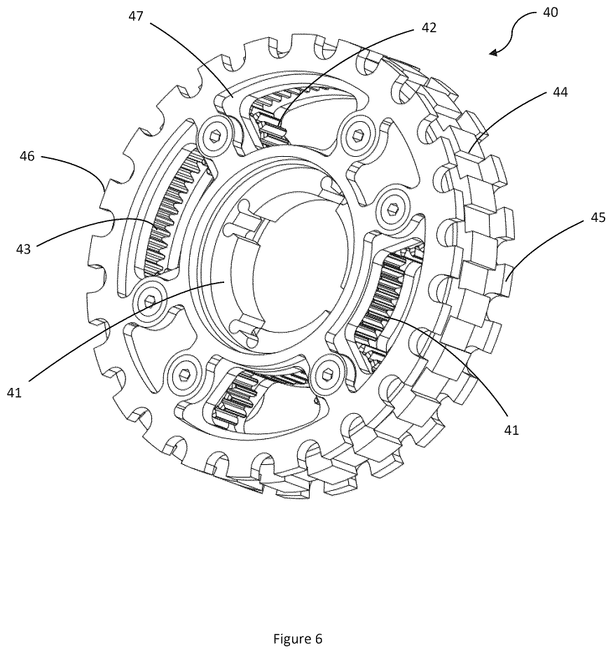

As shown in FIG. 5a, the drive assembly is mounted to the main shaft 11. It may be seen that a toroidal cavity 38 exists around the main shaft, bounded at the one end by the wheel hub 32 and at the other by a near brake drum 35. This cavity can receive an epicyclic gearbox 40 such as shown in FIG. 5b. This gearbox is shown in FIGS. 6 to 8. The gearbox is slidably mounted on the main shaft and can move axially on the main shaft so that it selectively engages with a driving dog clutch 37 and a driven dog clutch 34. By so doing, it transfers torque from 37 to 34 as will be explained in due course.

### Gearbox

FIGS. 6, 7 and 8 show one form of epicyclic gearbox 40 that may be used with the wheel assembly 1 of the invention.

The epicyclic gearbox 40 is capable of being driven by the rotating drive member/driving dog clutch 37 and transmits torque to the driven rotating element/driven dog clutch 34. Thus, both the driven and driving dog clutches 34, 37 are arranged to engage with the gearbox 40.

The assembled gearbox 40, as shown in FIGS. 6 to 11b, comprises a sun gear 41 that is attached to the main shaft 11 in an arrangement that prevents rotation of the sun gear 41 about the main shaft, but that allows the sun gear to slide axially along a portion of the main shaft 11. A plurality of independently rotatable planet gears 42 rotate about the sun gear 41 and engage with the sun gear via meshed teeth. The gearbox 40 also comprises a girdling ring gear 43 comprising inwardly projecting teeth that mesh with externally projecting teeth of each of the rotatable planet gears 42. The gearbox 40 further comprises an intermediate dog clutch 44, comprising a generally annular ring that is rigidly attached to and surrounds the ring gear 43 in a concentric arrangement. The intermediate dog clutch 44 is configured to be able to engage with the driving dog clutch 37 and the driven dog clutch 34.

The epicyclic gearbox 40 further comprises a first outer dog clutch 45 and a second outer dog clutch 46. Each of the first and second outer clutches 45, 46 are located adjacent to the intermediate dog clutch 44, such that the intermediate dog clutch is sandwiched between the first and second outer clutches 45, 46.

The driven and driving dog clutches 34, 37 each comprise inwardly projecting teeth configured to selectively mesh with outwardly projecting teeth of the intermediate dog clutch 44 and the first and second outer clutches 45, 46 in order to engage the drive assembly with the epicyclic gearbox 40.

As shown best in FIGS. 6, 7 and 8, the planet gears 42 are sandwiched between two washers 47, preferably Teflon washers, that are located between the planet gears 42 and the first and second outer dog clutches 45 and 46. In other words, a washer 47 is sandwiched between the first outer dog clutch 45 on one side, and the sun gear 41, planet gears 42 and ring gear 43 on the other side. A symmetrical washer 47 is provided on the other side of the sun gear 41 so as to be sandwiched between the second outer dog clutch 46 on one side and the sun gear 41, planet gears 42 and ring gear 43 on the other side. This arrangement allows for the epicyclic gearbox 40 to be axially constrained. Furthermore, the arrangement mandates that, when the sun gear 41 moves axially along the main shaft 11, all other components of the epicyclic gear 40 move simultaneously with it.

The planet gears 42 are fixed in position relative to the outer dog clutches 45, 46, but are each rotatably mounted about a respective spindle/stub shaft 42a. Each planet gear 42 rotates freely on its respective spindle 42a. Rotation of the planet gears 42 may be aided by bearings or bushings 42b.

Therefore, the planet gears 42, the driven and driving dog clutches 34, 37, ring gear 43, intermediate dog clutch 44, and outer dog clutches 45, 46 are each rotatable about the axis of the sun gear 41.

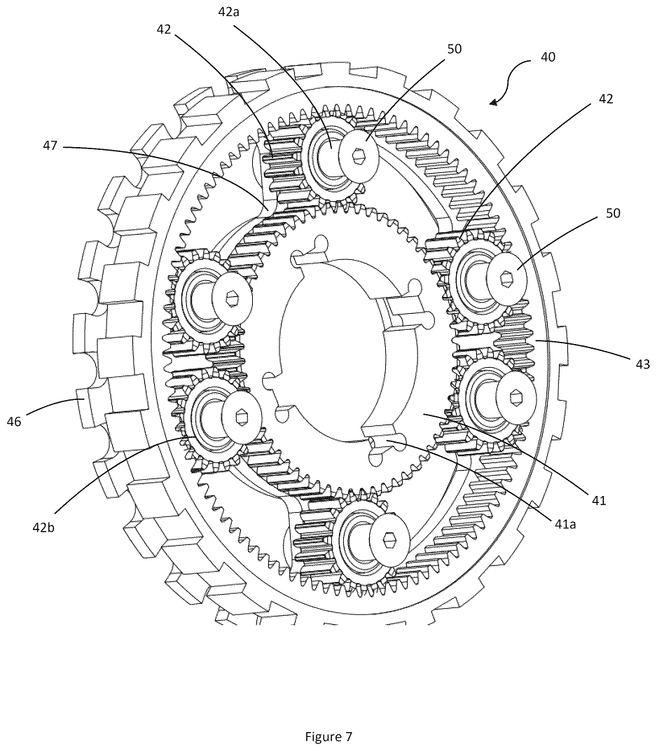

Each washer 47 comprises a plurality of holes, through which the spindles 42a of each planet gear 42 pass. Each end of each spindle 42a connects to the outer dog clutches 45, 46, such as via a fastener 50 (which may be a screw or bolt of any other suitable fastener), located at each end of the spindle 42a, as shown in FIG. 7. The fasteners 50 serve to position and clamp the outer dog clutches 45 and 46 onto opposing ends of the spindles 42a. Together, the first and second outer dog clutches 45, 46 and the spindles 42a provide a mounting structure for the planet gears 42. In this arrangement, as the outer dog clutches 45, 46 rotate about the sun gear 41, the planet gears 42 are each caused to rotate about the respective spindle 42a and to rotate about the sun gear 41 also.

The epicyclic gearbox 40 shown in FIGS. 6 to 8 comprises six planet gears 42, but it is envisaged that any suitable epicyclic gearbox 40 may be used and may comprise two or more planet gears 42.

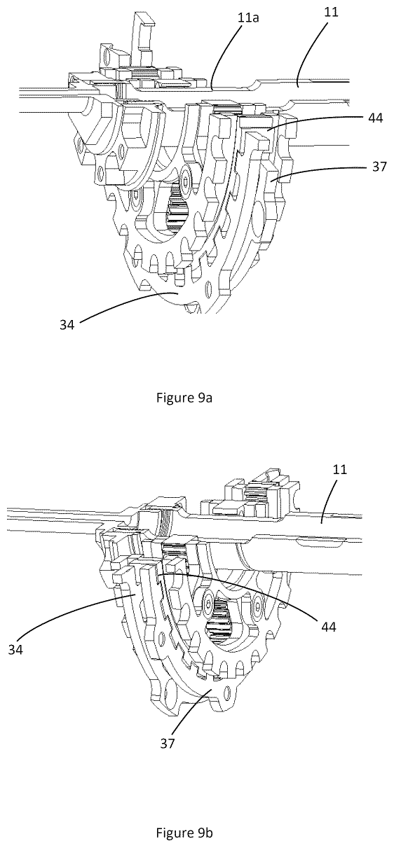

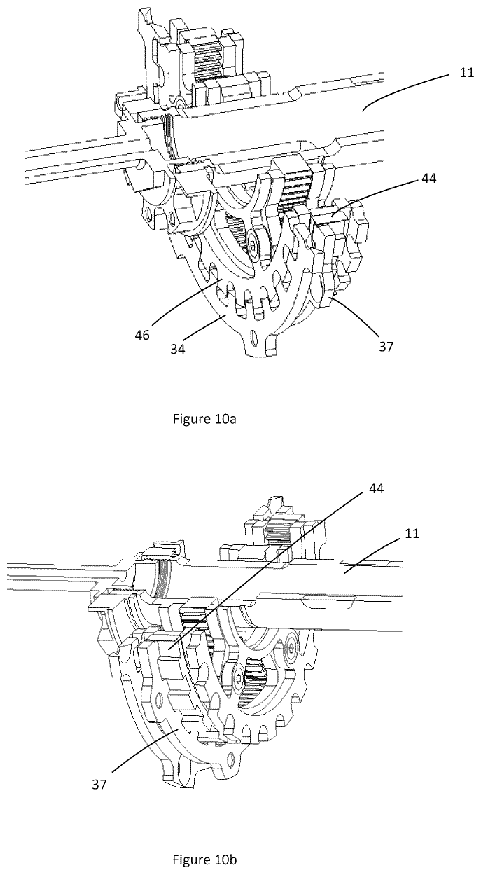

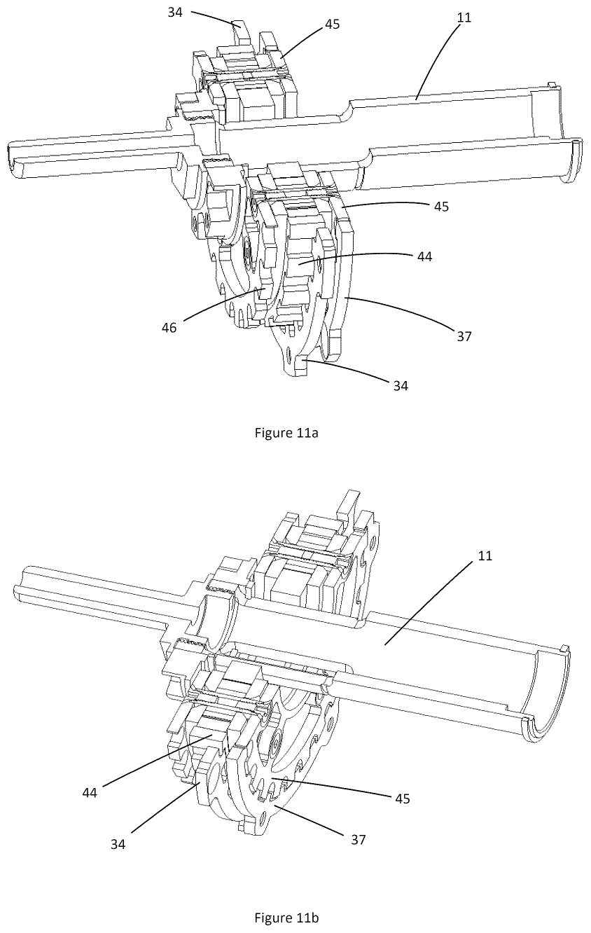

As exemplified in FIGS. 9a to 11b, the gearbox 40 is moveable between a first position, a second position, and a third position. The first position may correspond with a middle gear/second gear—FIGS. 9a and 9b. The second position may correspond with a low gear/first gear—FIGS. 10a and 10b, and the third position may correspond with a high gear/third gear—FIGS. 11a and 11b. In one arrangement, these three positions of the epicyclic gearbox can be set by moving the sun gear to appropriate stations as it slides along the main shaft.

### Drive Assembly

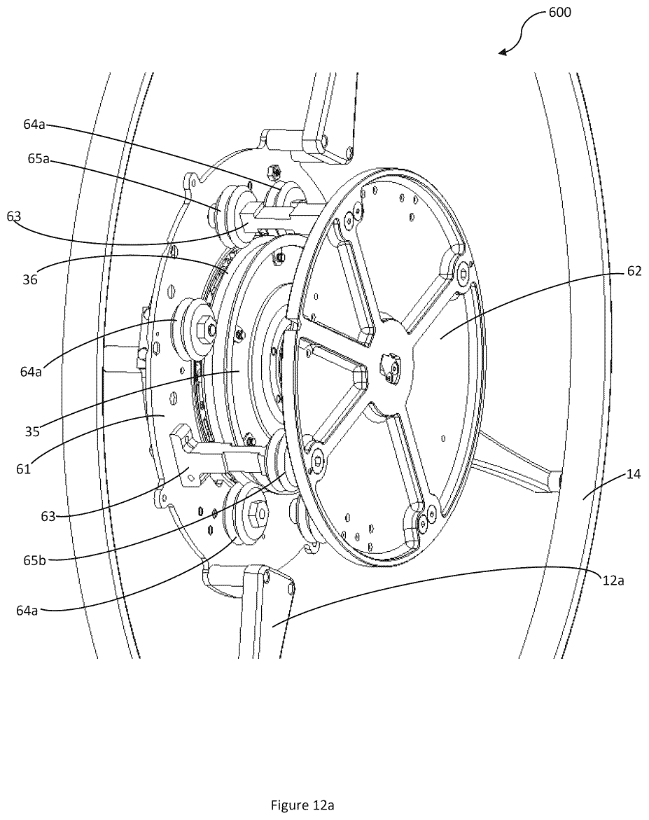

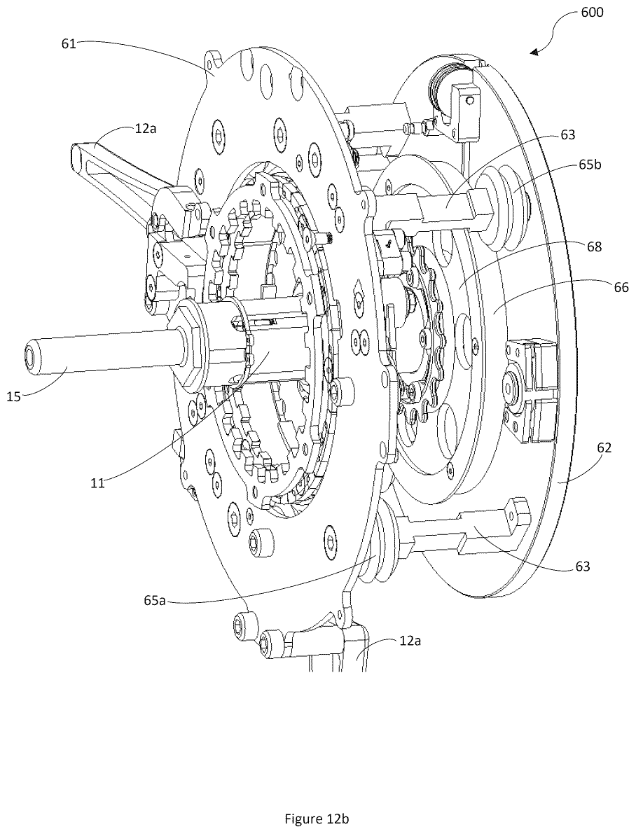

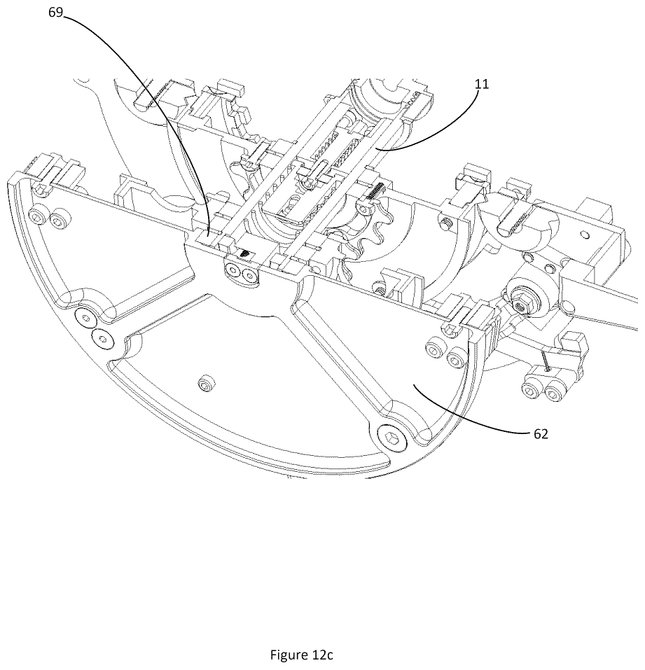

The drive assembly comprises, in FIG. 12a, a near brake drum 35 that is rotatably mounted on the main shaft 11 at a fixed axial station. The drive assembly further comprises a driven, rotating element 34, such as a first, driven dog clutch, which is attached to the wheel hub 32 and which rotates concentrically about the main shaft 11. A driving dog clutch 37 is attached to the near brake drum 35 and rotates concentrically about the main shaft 11. A collar 17 is attached to the near brake drum 35 and offsets the driving dog clutch 37 from the near brake drum 35. The driving dog clutch 37 and driven dog clutch 34 are associated with an epicyclic gearbox 40, which transfers rotational movement from the driving dog clutch 37, to the driven dog clutch 34 and so, to the wheel hub 32 to rotate the wheel 10.

The driven dog clutch 34 and the driving dog clutch 37 may each comprise a generally circular ring that is internally crenelated and has a central annulus. The driven dog clutch 34 and the driving dog clutch 37 are mounted adjacent to each other at a fixed distance apart, preferably 3 mm apart, as will be described in further detail in relation to FIGS. 6 to 11.

A bevel brake drum 36 forms a sleeve around the near brake drum 35 and is rotationally mounted on the main shaft 11. The bevel brake drum 36 is fixedly attached to the near brake drum 35, which is concentrically located within an annulus of the bevel brake drum 36.

### Oscillator

The drive assembly further comprises an oscillator 600, which allows the wheel assembly to operate in both the first and second modes. This is shown in FIGS. 12a and 12b. The oscillator 600 is configured to allow normal forward and backward motion of the wheel 10 when the wheel assembly 1 is in the first mode of operation and to transmit forward and backward motion of the pushrim 14 and control element 30 into solely forward motion of the wheel 10 when in the second mode of operation.

The oscillator 600 is mounted around the main shaft 11 and is configured to rotate about the main shaft and to bear axial and radial load. The oscillator 600 comprises a first end plate/near plate 61 and a second end plate/far plate 62, both plates 61, 62 being concentrically arranged about the main shaft 11. The oscillator 600 also comprises a chain assembly 700 to allow the drive direction of the oscillator to be reversed while in the second mode of operation. The first and second end plates 61, 62 of the oscillator are attached together in a spaced apart relationship by four or more connecting spacers 63, as shown in FIG. 12a.

The first end plate 61 comprises an inwardly facing first surface that faces toward an inwardly facing second surface of the second end plate 62. The spacers 63 extend between the first and second surfaces of the first and second plates 61, 62. The spacers 63 provide rigidity to the oscillator 600 during operation and also act as mounting stations for wedge cam followers, to be described later in the specification.

The oscillator 600 is connected by spokes 12a to the pushrim, which is also connected to a control column 91 in FIG. 4. The spokes 12a extend from the first plate 61, as shown in FIG. 12a, via offsets, and connect with the pushrim 14, so that rotation of the pushrim causes simultaneous rotation of the oscillator 600 and the control column 91.

As shown in FIG. 12a, a plurality of first cam followers 64a are rotatably and adjustably mounted on the first plate 61 and engage with a contact surface of a bevel brake drum 36. The bevel brake drum 36 is rotatable about the main shaft 11 and is fixedly mounted to the near brake drum 35, which is located within a central annulus of the bevel brake drum 36 and is thus rotatably mounted on the main shaft 11. The near brake drum 35, bevel brake drum 36 and the first plate 61 are concentrically arranged around the main shaft 11. Thus, the first cam followers 64a radially and axially locate the first plate 61 around the main shaft 11 by concentrically locating the first plate 61 relative to the bevel brake drum 36 and therefore relative to the main shaft.

Each first cam follower 64a preferably comprises a Vee'ed contact surface for engagement with a complementary bevelled contact surface of the bevel brake drum 36.

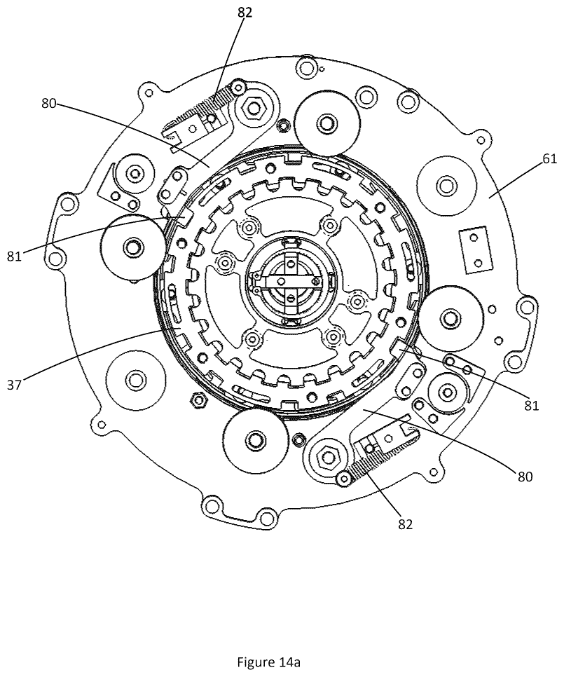

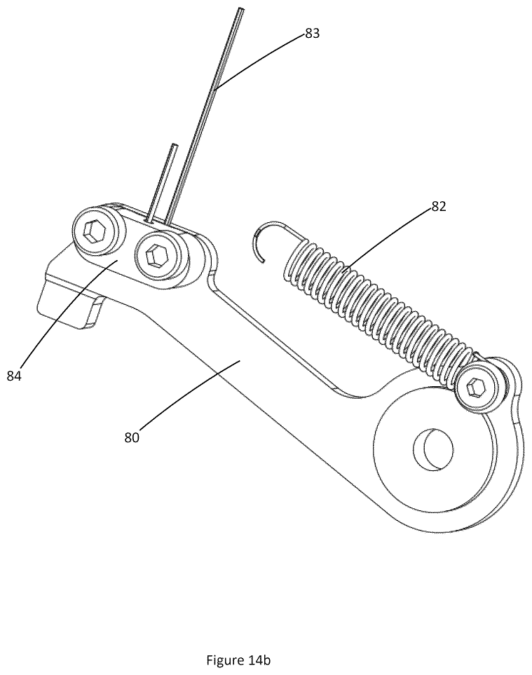

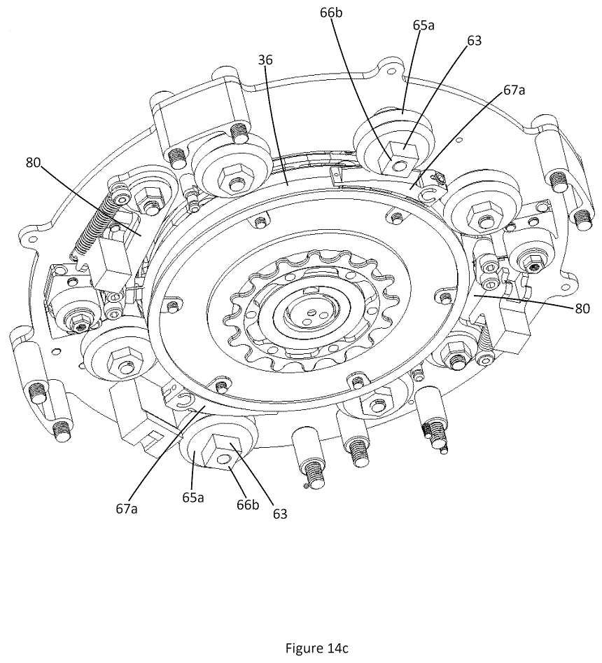

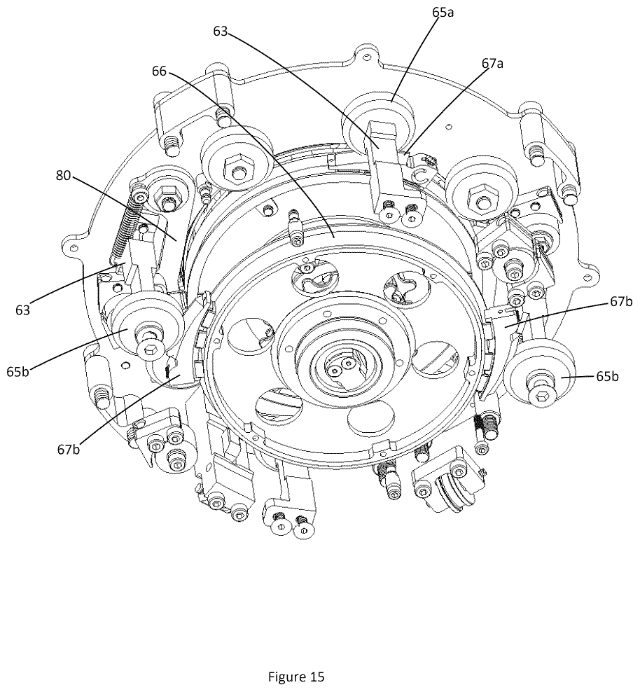

To allow the oscillator 600 to provide forward propulsion of the wheelchair upon receiving forward and also backward impulses from a user (via the pushrim 14 or control element 30), the oscillator comprises a plurality of first and second friction wedges 67a, 67b together with first mode locking pawls 80—as detailed in FIGS. 14a, 14b, 14c and 15.

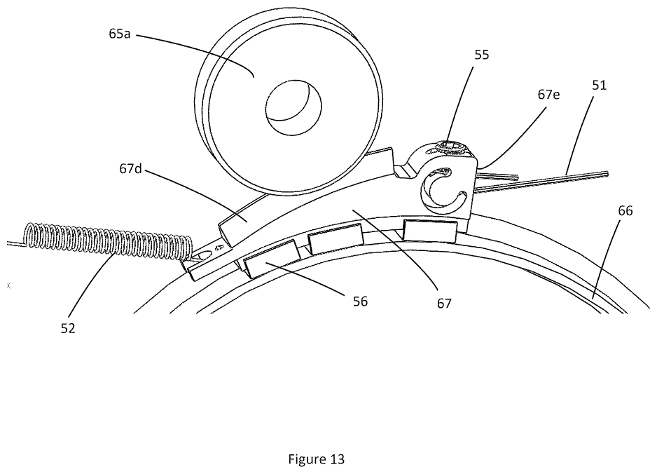

FIG. 13 typifies the way that the first and second wedges 67a, 67b nest against the respective bevel brake drum 36 or flat brake drum 66, and engage with a plurality of respective first and second wedge cam followers 65a, 65b that are rotatably mounted on the spacers 63 between the first and second end plates 61, 62. The friction wedges 67a, 67b and wedge cam followers 65a, 65b are arranged to be effective as one-way clutches, capable of being disabled or, when enabled, preventing relative motion between the oscillator and the relative brake drum, in one direction only.

The friction wedges 67b, which are associated with the flat brake drum 66 will be described in detail first. However, it should be appreciated that the friction wedges 67a, which are associated with the bevel brake drum 36, are configured in generally the same manner, though they lack the capability to be disabled.

A stabilizing bearing 69 is provided at the end of the main shaft, 11, as shown in FIG. 12c. This bearing is received into a mating cavity in the far plate 62. This arrangement assures that the oscillator 600 rotates concentrically about the main shaft, even when various loads are applied to the oscillator.

In FIG. 13, a rigid wedge-shaped structure 67 has a plurality of friction pads 56 associated with it, interposed between the wedge and a brake drum, but rigidly attached to the wedge. In a preferred configuration, the wedge has a crescent form so that the outer surface 67 provides a radial offset proportional to angular rotation of the wedge about the centre of the brake drum 66. Consequently, as the friction pads wear in service, the angle of contact and therefore the forces associated with the wedging action will be essentially constant.

The friction wedge 67 operates between the cam follower 65a and the brake drum 66. The cam follower 65a is constrained to have its centre of rotation at a fixed radius from the centre of the drum. In a preferred configuration, the cam follower 65a has a bevelled load surface and this mates with a commensurately bevelled surface 67d, in FIG. 13, on the outside of the wedge. This artifice helps to control the position and the orientation of the wedge in service. A tension spring 52 applies a small force, tending to draw the wedge into the “pinch point” between the brake drum 66 and the cam follower 65a. An agency, in a preferred configuration, a fine wire rope 51 is attached to the wedge at its end 67e in FIG. 13, using a setscrew 55. In active operation, the spring will draw the wedge into the pinch point and, if the drum 66 is rotated counter-clockwise in FIG. 13, the friction between the wedge and the drum will cause the arrangement to jam and the drum, wedge and cam follower will become rotationally locked. Therefore, rotation of the drum counter-clockwise will apply a torque to the oscillator. Conversely, if the oscillator is impelled to turn clockwise, in this depiction, jamming occurs, and the brake drum 66 will be impelled by the oscillator to turn clockwise. If the relative rotation between drum and wedge is reversed, friction will impel the wedge to move away from the pinch point and locking will not occur.

Therefore, this arrangement, when the cable 51 is slack, will operate as a one-way clutch and it may be described as “enabled”. If the cable 51 is tensioned, the wedge will be held away from the pinch point and the clutch may be described as “disabled” and when the oscillator turns, in either direction, such rotation will have little effect on the brake drum.

FIG. 14a shows a cross section of the drive unit showing the first end plate 61 to which are pivotally attached a plurality of mode one pawls 80. The latches pivot at one end, supported by bushings or bearings and, at the other, have a nib 81 or similar structure that can be received into a declivity in the periphery of the driving dog clutch 37. When the latch is active and engaged with the driving clutch, the driving dog clutch and the near end plate, and thus the oscillator are rotationally locked. In that case, the wheel assembly is in the first mode, where the pushrim rotates always in the same direction as the road wheel. This corresponds to the operation of the majority of commercial manual wheelchairs. In this mode, the friction wedges 67b, that operated on the flat brake drum are disabled so that this drum can rotate freely. In a preferred version, a tension spring 82 is attached to a mooring point on the latch as shown in FIG. 14b. This biases the latch to turn until the nib is engaged with the driving clutch 37. Also, in a preferred version a means such as a fine wire rope 83 or alternative mechanical arrangement acts on a mooring boss 84 and, when this is pulled, the latch disengages from the driven dog clutch and the latch no longer affects the rotational relationship between the driven dog clutch and the oscillator. The ability to provide a hard mechanical lock between the oscillator and the driving dog clutch 37 means that, if the wheel assembly becomes permeated by water and the friction wedges start slipping, the user can still propel himself in the first mode.

FIG. 14c shows a section through the drive unit. A plurality of first friction wedges 67a are configured to nest against the outer circumferential contact surface of the bevel brake drum 36. The activating springs 52 are not shown. The wedges can preferably be arranged in diametrically opposed pairs to balance the radial forces on the brake drum. The wedges act between the drum 36 and cam followers 65a. The cam followers mount on the spacers 63 that are shown with sectioned faces 66b.

Note that friction wedges 67a are not attached to a disabling cable as 51 in FIG. 13 but are instead controlled only by a tension spring 52, as shown in FIG. 13, but not shown here. This is to say that these wedges are always enabled and will, in FIG. 14c, prevent clockwise rotation of the first plate and the oscillator relative to the brake drum. Thus, clockwise rotation of the oscillator, under the impetus of the pushrim or control element will always cause the brake drum to rotate and thus to drive the road wheel.

FIG. 14c also shows a plurality of mode one pawls 80. In this representation, they are shown in the unlatched configuration where they do not mate with the driving dog clutch 37. And consequently, the first plate is free to rotate counter-clockwise in this figure with the friction wedges 67a sliding over the brake drum.

When the mode one latches are engaged, the first plate is locked, rotationally, to the brake drum.

As described above, each of the friction wedges 67a and 67b comprises a sloping contact surface for engaging with a respective wedge cam follower 65a and 65b. The sloping contact surface tapers at one end of the wedge and widens at the other end. Again, each friction wedge may comprise an outwardly curved, bevelled outer contact surface for contacting a bevelled outer contact surface of a respective wedge cam follower 65a and 65b.

Note that although it is preferred to employ wedge cam followers having a bevelled contact surface for engaging with a bevelled contact surface of the respective friction wedge 67a and 67b, it is not essential that the contact surfaces are bevelled. Instead, the contact surfaces may be flat. However, it has been found that using bevelled contact surfaces for the wedge cam followers 65a and 65b and friction wedges 67a and 67b provides greater positional control.

Therefore, the oscillator 600 engages with the actuating element(s) of the control column 91 to control activity of the friction wedges 67a and 67b and therefore the brake drums 36, 66 and the wheel 10.

In the first mode of operation, friction wedges 67b, acting on the flat brake drum 66 of the oscillator are disabled and the mode one locking pawls 80 are engaged. Then, the first plate is locked to the driven dog clutch, whether the oscillator is moved backwards or forwards and the function is the same as a normal manual wheelchair. Therefore, forward rotation of the pushrim 14 at its upper extent causes the bevel brake drum 36 to rotate forward (while the flat brake drum 66 slides freely under its disabled friction wedges 67b). Backward rotation of the pushrim 14 at its upper extent, causes the flat brake 66 drum to rotate forward (while the appropriate wedges 67b slide freely over the brake drum 66).

FIG. 15 shows the oscillator with the second plate removed. It may be seen that the wedges 67b act between the cam followers 65b and the flat brake drum 66 to function as one-way clutches, when they are enabled. Therefore, when the oscillator turns counter-clockwise in FIG. 15, it will impel the flat brake drum to turn counter-clockwise. When the oscillator turns clockwise in this figure, the wedges 67b will slide freely over the flat brake drum but the wedges 67a will transfer the rotation to the bevel brake drum 36

The oscillator 600 employs a chain assembly 700 to reverse the drive direction between the two brake drums 36 and 66 in order to capture the drive in each direction.

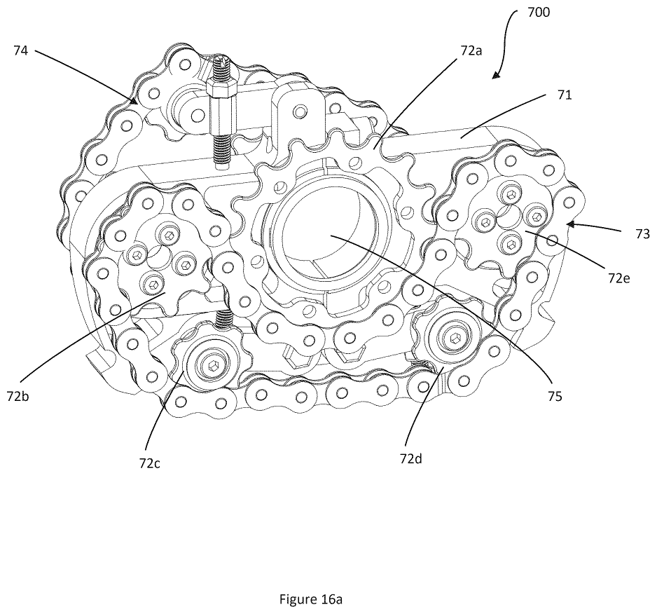

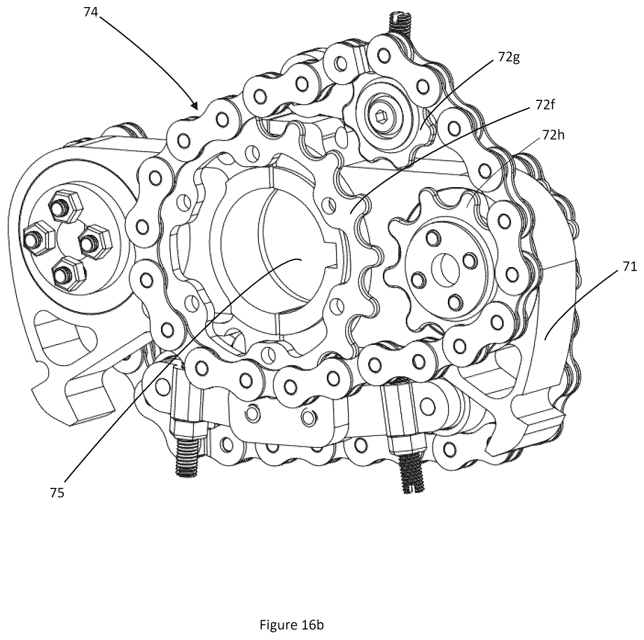

In one form, as shown in FIGS. 16a and 16b, the chain assembly 700 comprises a housing 71, having opposed first and second sides. A series of sprockets 72 are attached to the near and far brake drums and so positioned that they engage with a pair of first and second chains 73 and 74, each of the first and second chains 73 and 74 being located on the first and second sides of the housing 71 respectively. Each chain 73 and 74 follows a path around a series of sprockets, some mounted on the housing 71 and some on the brake drums.

As shown in FIG. 16a, on the first side of the chain assembly housing 71, the first roller chain 73 follows a path around a first sprocket 72a, around a second sprocket 72b, over first and second tensioning wheels/idler sprockets 72c and 72d, around a fifth sprocket 72e and so to closure. The second and fifth sprockets 72b and 72e are rotatably constrained by bearings in the housing 71 of the chain assembly 700. The housing 71 of the chain assembly is fixedly mounted upon the main shaft 11. The housing 71 may be formed in two parts and may be pinched onto the main shaft 11, perhaps with an included key system. FIG. 16a shows one form of housing 71 for the chain assembly.

The first side of the chain assembly 700 is adjacent to the far brake drum 68 and second end plate 62. The first side of the chain assembly therefore faces away from the mounting spigot 15. The first sprocket 72a is fixedly and concentrically mounted to a hub of the far brake drum 68. The flat brake drum 66 is fixedly attached to the far brake drum 68, which is concentrically located within an annulus of the flat brake drum 66. When the flat brake drum 66 and thus the far brake drum 68 is caused to rotate backwards by the oscillator 600, the first sprocket 72a simultaneously rotates in the same direction (counter-clockwise in the arrangement shown in FIG. 16a).

As shown in FIG. 16b, on the second side of the chain assembly housing 71, the second roller chain 74 follows a path around a sixth sprocket 72f, over a tensioning wheel/idler sprocket 72g, around an eighth sprocket 72h and so to closure.

The second side of the chain assembly 700 is adjacent the near brake drum 35 and faces in the same direction as the projecting spigot 15. The sixth sprocket 72f is fixedly and concentrically mounted to the near brake drum 35, as shown in FIG. 16b, such that rotation of the sixth sprocket 72f causes rotation of the near brake drum 35 and therefore rotation of the wheel 10.

The second sprocket 72b, on the first side of the housing, is fixed to an eighth sprocket 72h, located on the second side of the housing 71, so that both sprockets 72b and 72h turn in unison. Therefore, reverse rotation of the far brake drum 68 rotates the first sprocket 72a backward, which pulls on the first chain 73, causing the second sprocket 72b to rotate forward. The second sprocket 72b is connected to the eighth sprocket 72h, so the eighth sprocket 72h is also caused to rotate forward, which rotates the second chain 74 forward, causing the sixth sprocket 72f to rotate forward. The sixth sprocket 72f is attached to the near brake drum 35, so forward rotation of the sixth sprocket 72f causes forward rotation of the near brake drum 35.

The chain assembly 700 therefore operates to cause the first and sixth sprockets 72a and 72f to turn in opposite directions.

The three idler sprockets 72c, 72d, and 72g of the chain assembly 700 are adjustably positioned, controlled by lockable jackscrews.

Note that the chain assembly 700 can only transmit significant torque in one direction if the idler sprockets 72a, 72b, and 72f are not to be loaded. The chain assembly 700 may be used for either the left- or right-hand side wheel assembly, without modification, by reversing/flipping the assembly 700.

An aperture 75 is provided through the housing 71 and through the first sprocket 72a (located on the first side of the housing 71 and engageable with the first chain 73), and sixth sprocket 72f (located on the second side of the housing 71 and engageable with the second chain 74).

The main shaft 11 is fixedly received within the aperture 75. The chain assembly 700 is lockable to the main shaft 11 at a suitable axial location by any suitable locking means. In a preferred form, the chain assembly 700 is locked to the main shaft 11 by a typical pinch bolt arrangement and key (not shown).

With the interposition of the chain assembly 700, backwards rotation of the far brake drum 68 will coerce forward rotation of the near brake drum 35. By this means, either forward or backward movement of the oscillator can be transferred to forward rotation of the wheel 10.

### Gear Selection

Optionally, the wheel assembly 1 provides a user with the opportunity for gear selection. The selection of the gear ratio occurs when the sun gear and associated gearbox structure are moved to one of a plurality of axial positions on the main shaft, as depicted in FIGS. 9 to 11.

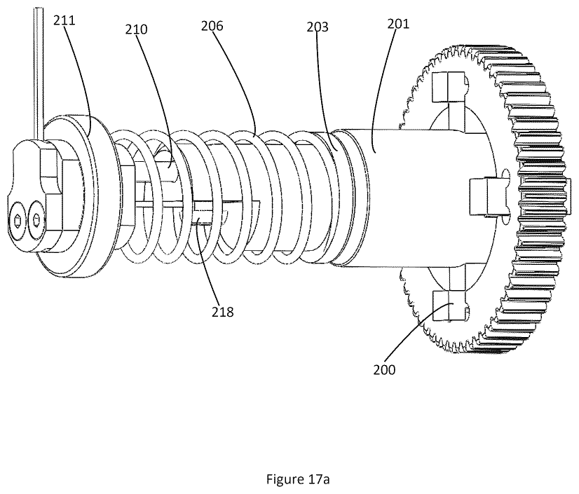

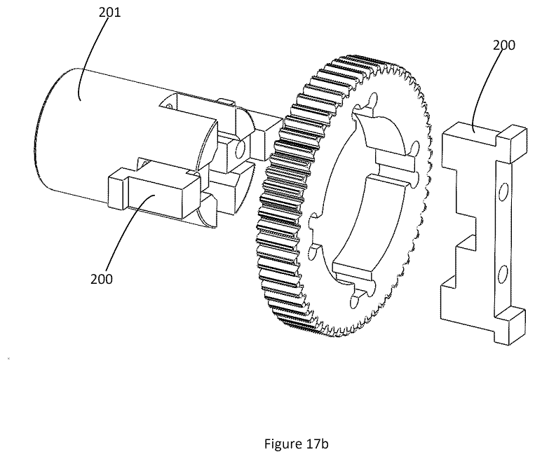

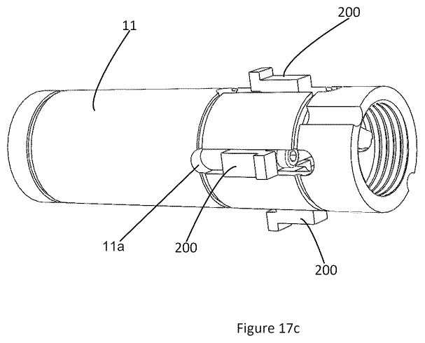

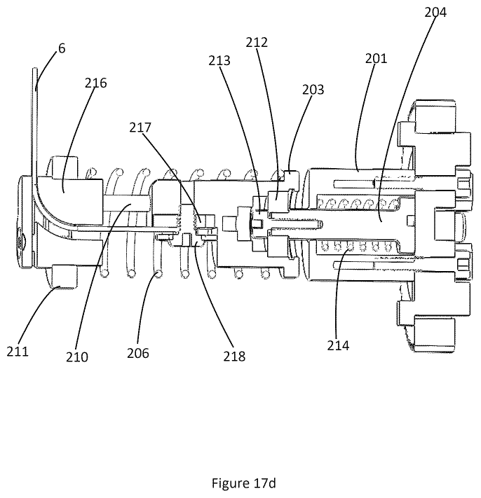

In one arrangement, FIG. 17a shows the sun gear rigidly connected to a structure that can slide within the main shaft. It is secured to this structure by means of two keys 200, between which it is sandwiched. FIGS. 17b and 17c show a detail of the nestable keys and the way in which they attach to a first cylinder 201 in order to lock the sun gear. The first cylinder 201, slides in a cylindrical cavity within the main shaft. A consequence of this arrangement is that the axial dimension of the wheel assembly is much shortened, with the necessary sliding bearing surface occurring within the main shaft. The bearing 211 is housed in a recess in the end of main shaft cylindrical cavity, in FIG. 17d. As shown in FIG. 17c the keys are so arranged that they fit snugly within and protrude from four slots 11a in the main shaft. As shown in more detail in FIG. 17b, this arrangement clamps the sun gear rigidly in position between the keys, so that the plane of the ring gear is constrained to lie substantially orthogonal to the axis of the main shaft. Further, the ends of the keys are received within mating slots 41a on the inside of the sun gear, preventing rotation of the sun gear relative to the keys and the main shaft. Further, this arrangement ensures that the sun gear moves commensurately with the first cylinder. The other gears in the epicyclic gearbox move commensurately with the sun gear and therefore, by moving the first cylinder within the main shaft, the several locations of the epicyclic gearbox that are depicted in FIGS. 9 to 11 may be selected and the corresponding gear ratios may be achieved.

FIG. 17d shows a section through the structure depicted in FIG. 17a. A second cylinder 203 is axially aligned with the first cylinder, both of them sliding within the main shaft. Sliding axially within the first cylinder is a pin 204 whose smaller end fits into a ball bearing 212. The bearing is retained on the end of the pin by a socket head cap screw 213, which holds the bearing against a shoulder of the pin. The bearing is retained in the second cylinder by a circlip or similar means. Consequently, the second cylinder moves axially exactly as the pin 204 moves. Around this pin is coiled a first compression spring 214. The effect of this spring is to bias the pin so that its head tends to abut against the keys 200.

A second spring 206 exerts a repulsive force between the bearing 211 and the second cylinder 203. This force can be overcome by tension in one or a plurality of wire ropes 6. These ropes are fed through a hawsepipe 216 so that the direction of the force changes through a right angle in the same way that hawsepipes operate in ships. The wires wrap around a boss 217 in the second cylinder and may be held in position by a screw 218. When the wire(s) 6 are pulled upwards in FIG. 17d, this will cause the second cylinder to move to the left. When the wires are released, the second cylinder will tend to move to the right under the influence of the second spring 206. In this way, the position of the second cylinder and thus the epicyclic gearbox can be set to any axial location, within its range of movement. The second cylinder and the hawsepipe have a plurality of shafts 210 that slide freely within the second cylinder but are anchored in the hawsepipe. In this way, the hawsepipe and the second cylinder are constrained to retain the same angular orientation. The purpose of this arrangement is to avoid twisting the wire rope(s) 6. In FIG. 17a, it may be seen that the cover over the hawsepipe has a slot to allow the cable 6 to pass freely and further that the planform shape of this cover is keyhole in shape. In FIG. 12c, a half section through the far plate shows the way in which this keyhole-shaped cover over the hawsepipe 216 engages within a similar shape in the far plate 62. This locks the hawsepipe and the second cylinder into a fixed angular relationship with the far plate.

The ball bearing 212 allows the first cylinder to rotate relative to the second cylinder. Consequently, the second cylinder and hawsepipe can oscillate or rotate with the far plate while the first cylinder and sun gear are rigidly orientated with the main shaft, which is, in turn, locked to the wheelchair frame.

When the first cylinder moves to engage different dog clutches as the gearbox moves to change ratios, as depicted in FIGS. 9 to 11, the dog clutches will generally not engage until the clutches are rotationally aligned. When the cables 6 are slackened and the second spring moves the gearbox to the right in FIG. 17d, the force of this spring will bias the sun gear and thus the gearbox to the right until the appropriate dog clutches align and then the system will click into the new ratio.

However, when the cables are tensioned and the gearbox moves to the left, rotationally misaligned dog clutched will offer inflexible resistance. This will be inconvenient for the user.

The first spring 214 biases the pin 204 against the keys 200 but when the cables 6 are pulled in order to move the epicyclic gearbox to the left in FIG. 17d and the relevant dog clutches are not rotationally aligned, the pin 204 can be drawn out of the first cylinder, compressing the spring 214. Thus, the cable 6 can be drawn to its appropriate position to select a specific gear ratio and, when the clutches are aligned, the pin will re-establish its position against the keys and the gearbox will snap into place.

At all times, the second cylinder 203 is under conflicting forces, being pulled toward the bearing 211 by the connector 6 and impelled toward the first cylinder 201 by the first compression spring 206. The position of the second element 203 is therefore determined by the connector 6, unless the dog clutches associated with the epicyclic gearbox 40 cannot mesh. In such a scenario, the first compression spring 206 will be compressed and will remain in that condition and exert a biasing force on the second element 203 until, by relative rotation, meshing of the dog clutches is possible.

Because the first and second compression springs 206 and 208 are always in compression, when the dog clutches of the epicyclic gearbox 40 are in mesh (and offering no axial force to the epicyclic gearbox 40), the gearbox 40 is held firmly in its position, requiring a force to displace it, relative to the position of the connector boss 217. Consequently, the mesh of the dog clutches is fixed by the position of the connector boss 217, which is fixed in turn by wire ropes 6. Therefore, gear selection occurs by pulling the connector 6 to a specific position against the spring 206.

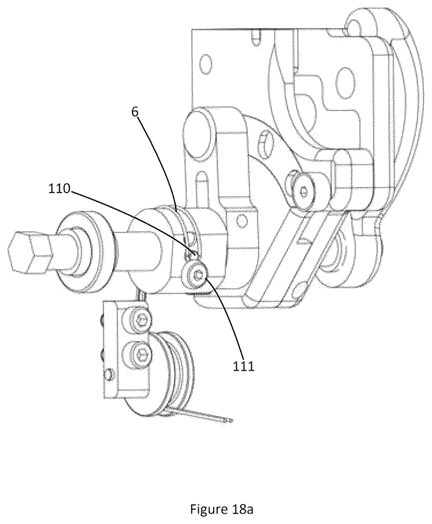

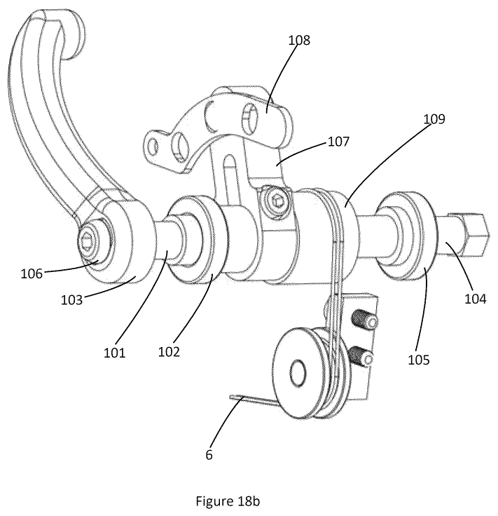

One possible gear selection system is depicted in FIGS. 18a and 18b and comprises a first motion shaft 101 that is rotationally mounted in a bearing 102, housed in the control housing. The first motion shaft 101 comprises two flats on one end of the shaft that protrudes from the control housing. A handle, 103, has a mating aperture that receives the protruding end of the first motion shaft 101 and by this, or other means, the handle 103 is kept in a fixed rotational relationship with the first motion shaft 101.

Abutting and co-axial with the first motion shaft is a second motion shaft 104, also rotationally mounted in a bearing 105 in the control housing. The protruding end of this second shaft may have a hexagonal protuberance on the end. Concentrically in the end of the second motion shaft 104, remote from the hexagonal feature, is tapped a screw thread, which receives a screw 106, inserted and passing concentrically through the first motion shaft 101. When this screw is tightened, axial forces and friction between the shafts cause the two shafts 101, 104 to behave monolithically, and no rotation is possible between them. When the screw 106 is loosened, it is possible to turn the second motion shaft 104 with a wrench/spanner applied to the hexagonal portion and, by this means to change the rotational relationship between the two shafts 101, 104 before the screw is re-tightened. As will be explained later, this allows adjustment of the gear selection system.

A detent arm 107 is fixedly attached to the first motion shaft 101, such as by using a pinch bolt arrangement or any other suitable form of attachment or angular registration. The detent arm comprises a distal end in which is located a compression spring and ball bearing that can engage with any one of a plurality of detent slots in a hardened member 108. Therefore, the handle 103 can be manipulated to settle in any one of several detented angular positions, each of which will correspond to a winding in of the cable 6 and therefore to a specific gear ratio.

A cylindrical enlargement 109 of the first motion shaft 101 serves as a capstan around which the gear changing connector 6 can be wound. The end of the connector 6 is anchored to this capstan. In one possible arrangement, detailed in FIG. 18a, the member 6 is looped around a short peg 110 that is inserted radially into the cylindrical enlargement 109 and the cable is looped over it and is trapped by the head of a screw 111.

In effect, rotation of the handle 106 to any detented position will cause the member 6 to be wound in or out and will therefore lead to a corresponding movement of the epicyclic gearbox 40 along the main shaft 11 to a position corresponding to the desired gear ratio.

In order to assure that each detent position corresponds very closely to the optimal position of the epicyclic gearbox 40, adjustment is possible by firstly setting the handle 106 to select a desired gear ratio, slackening the bolt, rotating the second motion shaft 104 using the hexagonal head and then retightening the bolt in this condition.

### Changing the Mode of Operation

To change the mode of operation of the wheel assembly between the first and second modes, the control column incorporates a mode change drum 250 in FIG. 19a, which is rotatably mounted to the control column 91. A plurality of connecting members 251, such as wire ropes or an equivalent mechanical system effects a rotation of the drum 250 as a consequence of changing the position of a slug 252 that slides within a suitable cavity in the control housing 61. When this slug is in its lowest position in FIG. 19a, the connecting member 251 is slackened and the drum turns clockwise under the influence of a spring 255 in FIG. 19b, to the extent permitted by the member 251. The drum is affixed to a shaft 253 in FIG. 19b that is rotatably mounted in bearings or bushings and protrudes from the remote side of the control column 91. A crank 254 is fixedly attached to the end of the axle, remote from the drum and the tension spring 255 pulls the end of the crank upward, causing the connecting member 251 always to be in tension. This configuration, where the slug is in its lower position and the mode change drum has rotated fully clockwise under the influence of the spring 255 exists when the handle is extended. This corresponds to the second mode of operation of the wheel assembly.

When the handle is furled, as seen in FIG. 19c, one of the quadrant plates 9a engages with the slug 252 and raises it to its fullest extent. The connecting member 251 pulls on the mode change drum, causing it to turn counter-clockwise in FIG. 19c, thus extending the spring 255.

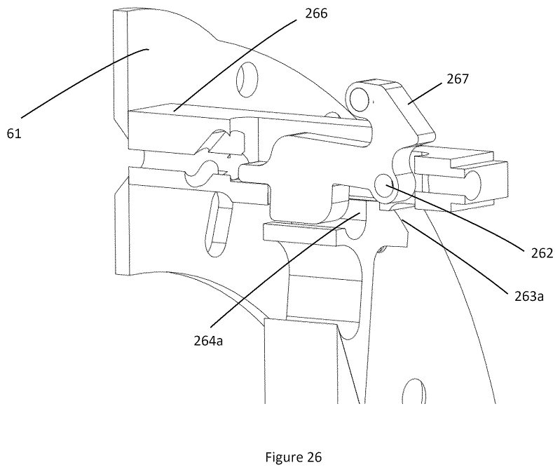

Four flexible cables 258, 259, 260, and 261 are affixed to the drum and pass therefrom into the sheaths of Bowden cables 257 and 256 respectively, as shown in FIG. 19d. Cables 258 and 259 are attached to the wedges 67b, which operate on the flat brake drum. Cable 260 is connected to the mode one pawls 80 in FIG. 14c. Cable 261 is connected to the snubbing mechanism, described in due course and depicted in FIG. 26. It may be apprehended that when the handle is furled and the wheel assembly is in the first mode of operation, cables 258 and 259 are tensioned and cables 260 and 261 are commensurately slackened. Cables 258 and 259 are connected to the friction wedges 67b that act on the flat brake drum 66. When these members 258 and 259 are tensioned, the friction wedges 67b are disabled, and the flat brake drum is free to rotate in either direction.

Cables 260 and 261 are attached to the mode one pawls and to the snubbing mechanism and when they are slackened, they permit the mode change pawls under the influence of the springs 82 to engage with the driving clutch and to lock the oscillator rotationally to the driving clutch. Therefore, the wheel 10 will always rotate in the same direction as the pushrim and the wheel assembly is operating in the first mode, with the flat brake drum free to turn in either direction. Further, they release the blade 267 of the snubbing mechanism that, under the influence of a spring moves into a position to snub the motion of the oscillator.

When the control element 30 is deployed, the mode change drum is drawn by the spring 255 into a clockwise posture. This tensions the cables 260 and 261 and relaxes the cables 258 and 259. Relaxing cables 258 and 259 causes the wedge clutches on the flat brake drum to be enabled and to permit relative motion of the brake drum only in one direction. Simultaneously, the cables 260 and 261 are tensioned and they draw the mode one pawls 80 away from the driving clutch 37, allowing the bevel brake drum to move under the control of the wedges 67a and they de-activate the snubbing mechanism.

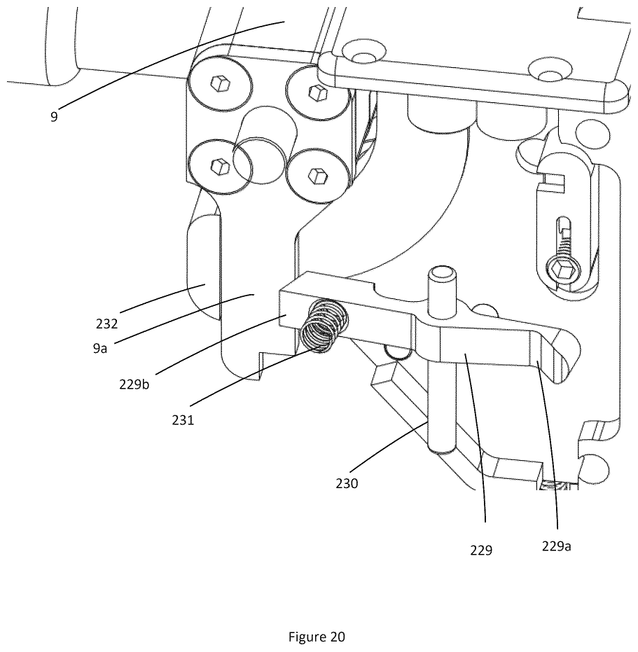

In preferred forms, the control element 30 may be locked in the second position by a latch assembly, as shown in FIG. 20. In the embodiment shown, the second position of the control element (which may be referred to as its functional position) is orthogonal to the sagittal plane of the wheelchair, but it will be appreciated that orientation of the control element 30 and other components of the invention may be altered without departing from the scope of the invention.

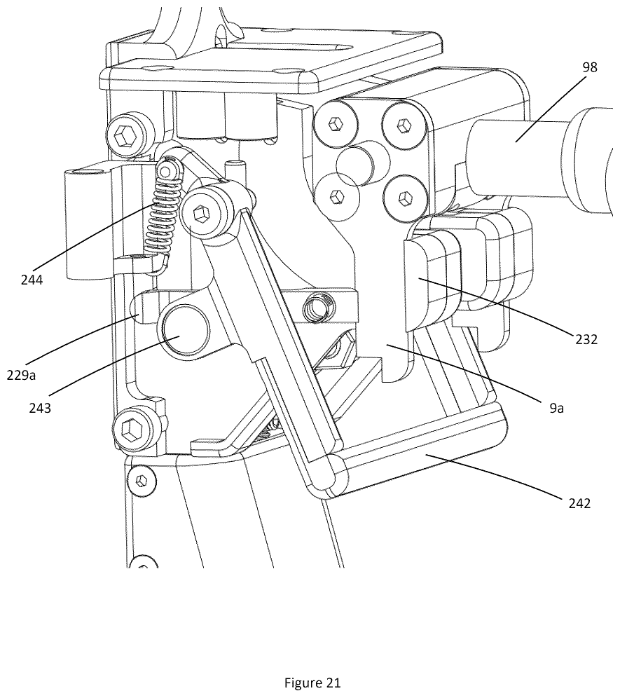

As shown in FIGS. 20 and 21, the latch assembly may comprise a locking lever 229. In some forms, the locking lever 229 is formed from hardened steel. The locking lever 229 pivots about a shaft 230 mounted in the control column 91. The shaft 230 is located between an engagement end 229a of the locking lever 229 and a distal end 229b.

In some forms, the engagement end 229a of the locking lever comprises a protruding surface that projects away from the control column 91. In some forms, the protruding surface is provided by a tuberosity located at the engagement end 229a of the lever. In another form, the locking lever 229 may comprise a hooked engagement end.

In some forms, the distal end 229b of the lever comprises an inclined surface configured to contact the arm 9a.

A compression spring 231 is mounted on the lever 229 at or near the distal end 229b of the lever. In some forms, one end of the compression spring 231 is located within a blind recess provided on the lever 229. The other end of the compression spring 231 is configured to press against a member of the control column 91 (not shown).

The locking member 242 is pivotally mounted on the control column and is moveable between the locked position (in which to lock the control element in the second position) and an unlocked position (in which the control element may be moved to the first position). In some forms, a spring 244 is attached to the locking member 242 and to the control column 91 and biases the locking member 242 to the locked position.

When the locking member is rotated clockwise in FIG. 21, a friction disc 243, embedded in the locking member is caused to slide across the tuberosity 229a and, in so doing to press the tuberosity inwards towards the centre of the control assembly, thus causing the end of the locking pawl 22b to disengage from the quadrant plate 9a and thus freeing the control element to move away from its extended disposition.

In one form, to stabilise the control element in the second position, an edge of the arm 9a butts against a land 232 provided on the control column 91. Any slight rotational movement of the control element 30 is removed because the inclined face of the distal end of the locking lever 229 presses firmly against the arm 9a, as shown in FIG. 20. Consequently, the locking lever 229, under the influence of the compression spring 231, will adjust its rotational position until the arm 9a does not move. An equivalent arrangement may be provided on the other side of the mounting block 9.

In the arrangement shown in FIGS. 20 and 21, the locking member 242/243 is pivotable bilaterally on the control column 91 and can be pushed down to unlock the control element 30 from the second position and to permit the control element to move to the first operating position. Unlocking the control element 30 therefore allows the control element to be rotated downwards to the first operating position.

### Braking

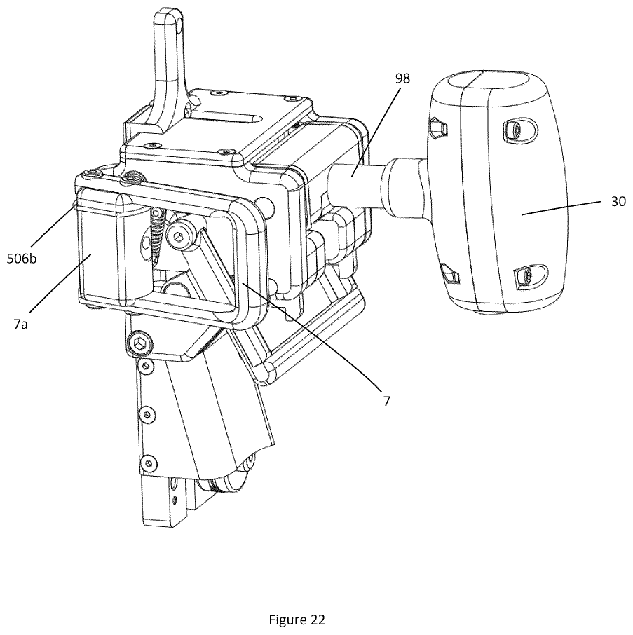

The wheel assembly 1 also comprises a braking system. In preferred forms, as shown in FIG. 22, a brake lever 7 is rotatably mounted on the control column 91, proximate the control element 30. The brake lever 7 is within easy reach of the control element 30 and is comfortably placed so that the user's thumb or palm can reach the lever 7 and push it forward in order to effect braking. This arrangement of the hand allows the user, using four fingers, to withstand the effect of braking which impels the control element 30 to move forward. In the embodiment shown in FIG. 22 a capstan 7a, attached to the brake lever 7 is pivoted bilaterally over a housing of the control column 91. A wire rope 506b leads from the capstan, through a Bowden cable to a braking mechanism.

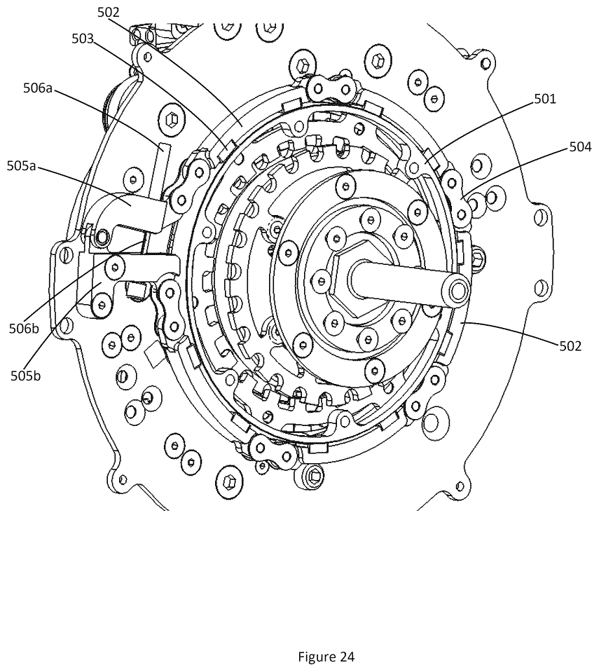

One form of a braking system for applying braking to the wheel assembly 1 is depicted in FIG. 24.

A cylindrical annular main brake drum 501 is rigidly and concentrically attached to the wheel hub, which is, in turn attached to the spokes 12 and the road wheel 10. Any retarding effect applied to this drum will therefore be transmitted, as braking to the wheel 10. A plurality of brake links 502 can be coupled together by roller chain master links 504 to form a flexible structure that encircles the main brake drum. Friction pads 503 may be fixedly attached inside the brake links. Both sides of a scissors mechanism are shown as 505a and 505b. One member 505b is rigidly attached to the near plate, in this configuration, by screws. The moving side of the scissors is rotationally attached to the stationary side, so that a scissors motion is possible. The two extremes of the circular braking structure are attached respectively to the two ends of the scissors. A brake cable 506b passes through the two members of the scissors and is led away inside a Bowden cable 506a to a brake lever 7, positioned on the control column. A spring, not shown, may be interposed between the two members of the scissors in order to keep them open and avoid tension on the circular structure.

The arrangement, as shown in FIG. 24, is appropriate for a right-hand wheel of a wheelchair, in which case, forward motion of the wheelchair will tend to tighten the girdle in operation and increase the effect of braking.

The brake lever 7 is attached to a rotatably mounted capstan 7a, about which is wound a connecting element 506b, such as a cable, wire rope, or the like. In some forms, as shown in FIG. 22, the connecting element 506b is attached to the capstan by passing around the capstan and then entering a slot 7b in the capstan 7a. Tapped into the slot is a fastener 7c, such as a set screw or the like, that secures the connecting element 506b to the capstan.

The connecting element 506b passes through the Bowden cable 506a. In a preferred form, the connecting element 506b enters a sleeve of the Bowden cable and forms part of the Bowden cable. The connecting element 506b therefore transmits tension from the brake lever to the brake mechanism.

In this arrangement, by rotating the brake lever 7 to the engaged, brake position, the connecting element 506b is pulled around the capstan, applying tension to the Bowden cable, which closes the scissors 505a and 505b and applies the brakes.

When the wheel assembly is in its second mode, the control element 30 and control column 91, under their own weight, are inclined to rotate towards the bottom portion of their circular trajectory. This is unsatisfactory because such rotation would mean that the control element 30 and brake actuators 7, are not easily accessible to a user of the wheelchair. Reaching the brake lever quickly may be very important to the user.

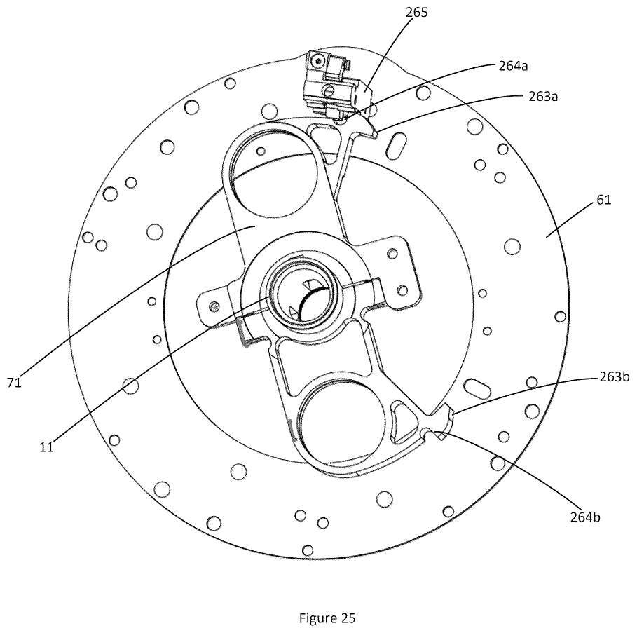

To prevent such a disadvantageous eventuality, the wheel assembly 1 of the invention may comprise a snubbing mechanism 265, as shown in FIGS. 25 and 26. In the embodiment shown, the snubbing mechanism comprises a housing 266, which is attached between the first plate 61 and the second plate 62 and within which is provided a blade 267 in FIG. 26. The blade 267 is pivotably mounted about a shaft 262 and is moveable between an engaged position and a disengaged position. The orientation and therefore the position of the blade 267 is controlled by a spring and a Bowden cable (not shown), so that the blade 267 is spring loaded into the disengaged position when the control element 30 is in the furled disposition. In effect, when the control element 30 is deployed, the mode change drum assumes a clockwise condition and a cable attached to the mode change drum is tensioned, resulting in the blade 267 protruding from the housing 266. In this condition, it will cause the nibs, 264a and 264b to snub against the blade and prevent the control element 30 from moving into the lower portion of its trajectory. When the control element is already in the lower portion and is brought upwards against the snubbing blade, the blade will slide up over the angled faces 263a and 263b and so ratchet into the upper portion.

The chain assembly housing 71 of the oscillator comprises a pair of first and second radially projecting engagement members 263a and 263b each comprising a projecting portion that faces in the opposite direction to the other. Each of the engagement members 263a and 263b comprises a respective land 264a and 264b configured to engage with the blade 267 to snub the oscillator.

Thus the invention involves in its many aspects a wheel assembly for a wheelchair, the wheel assembly comprising a wheel, a drive assembly, and a control member whose radius of gyration falls within the radius of the wheel, the control element being operably engaged with the wheel via the drive assembly to propel the wheelchair in a mode of operation, wherein the control element is operable in a way that translates motion of the control member either in a first direction or else in an opposite direction into motion of the wheelchair in a single direction.

The wheel assembly further comprising a pushrim and the ability to operate in a different mode where the wheel turns always in the same direction as the pushrim is turned.

In an embodiment, a main shaft comprises a spigot attached axially and concentrically, to engage the wheel assembly with a hole in a frame of the wheelchair.

In an embodiment, the control element can be furled, so that its axis lies in a plane that is functionally orthogonal to the axis of rotation of the wheel assembly, or else the control element can be deployed and latched, so that it protrudes from the plane of the pushrim, and its axis is substantially parallel to the main shaft of the pushrim and can be grasped by a user and where such furling or unfurling changes the mode of operation of the wheel assembly from that outlined in paragraph [0176] to that outlined in paragraph [0177].

The wheel assembly further comprising wedges, positioned between rotary cam followers and discs, rotatably mounted on the main shaft, such wedges being drawn into a pinch point between the cam followers and the discs by springs acting between the wedges and a structure supporting the cam follower and being configured to lock rotation between the cam follower and the disc, when turned in one direction and to slide when turned in the other direction.

In an embodiment, a friction material is interposed between the wedge and the rotatable disc.

In an embodiment, the rotatable disc is sleeved, fixedly and circumferentially, with some material that can rub sustainably against the friction material.

In an embodiment, the wedges comprise curved inner surfaces to substantially conform to a curved outer edge of the rotatable disc.

The wheel assembly further comprising mechanical or electrical means that engage with the wedge to withdraw the wedge away from the pinch point between disc and the cam follower and to disable interaction between cam follower and rotatable disc.

In an embodiment, a Vee'ed cam follower engages with a ridge on the wedge to restrain lateral movement of the wedge.

The wheel assembly comprising and mounted on the main shaft, a first rotatably mounted disc or first brake drum and a second rotatably mounted disc or second brake drum, the rotatably mounted discs configured to be rotationally impelled by wedges that are induced to jam in pinch points between the cam followers and the brake drums.

The wheel assembly comprising a contra-rotation mechanism that causes any rotation of the first brake drum in any direction to cause rotation of the second brake drum in the contrary direction and any rotation of the second brake drum in any direction to cause rotation of the first brake drum in the contrary direction.

In an embodiment, the contra-rotation mechanism comprises two roller chains and a plurality of roller chain sprockets that are interposed between the first and second brake drums.

In an embodiment, on a first side of the chain assembly, a loop of roller chain passes around locationally fixed but rotationally mounted sprockets and around a third, driving, sprocket, this sprocket being fixed to the far/second brake drum, the arrangement providing that the side of this chain that is in contact with the fixed sprockets is not in contact with the driving sprocket, thus causing the driving sprocket to rotate in the sense opposite to the two fixed sprockets.

In an embodiment, on a second side of the chain assembly, a loop of roller chain runs over a locationally fixed but rotationally mounted sprocket and around a driven sprocket, this sprocket being concentrically fixed to the first brake drum, this arrangement assuring that this fixed sprocket always turns in the same direction as the driven sprocket.

In an embodiment, two fixed but rotationally mounted sprockets, one on either side of the chain assembly, each engaged with a different loop of roller chain, are locked together and therefore rotate identically, transmitting the drive between the two sides of the chain assembly.

The wheel assembly comprising an epicyclic gearbox composed of a sun gear, a plurality of planet gears and a ring gear, such gearbox being positioned concentrically about the main shaft.

In an embodiment, all the gears of the gearbox are sandwiched between two discs, these discs being affixed on either side to a plurality of stub axles, about which the planet gears can rotate, with screws passing through these discs and into threads in the stub axles, thus making a rigid structure.

In an embodiment, two discs of a material such as teflon are interposed, one on either side, between the outer discs and all the gears, this arrangement assuring that when the sun gear is translated along its axis of rotation, all the components of the gearbox move in lockstep.

In an embodiment, the outer discs of the epicyclic gearbox have their periphery regularly crenelated to form dog clutches, with the teeth facing outward.

In an embodiment, a sleeve is pressed fixedly over the ring gear of the epicyclic gearbox, such sleeve having its outer surface machined to provide a dog clutch of identical dentation to the outer discs of the gearbox.

In an embodiment, crossed keys are inserted diametrally into the slots in the main shaft, to extend on either side and engage in slots in the inner surface of the ring gear, such slots having lands so that, when the crossed keys are nested the lands will press on either side of the ring gear.

In an embodiment, the crossed keys are securely attached to a member, in a preferred arrangement, a first cylinder that is a sliding fit in the main shaft, the assemblage ensuring that the sun gear moves irrotationally along the axis of the main shaft but is at all times substantially orthogonal to the main shaft.

The wheel assembly having a second cylinder that is concentric with the first cylinder and slides in the main shaft on the side of the first cylinder away from the spigot and can be drawn away from the first cylinder against a first spring within the first cylinder, can rotate freely with respect to the first cylinder but cannot be moved closer to the first cylinder than its quiescent position where it is almost touching the first cylinder, such second element offering an anchor point to attach one or a plurality of fine wire ropes to it.

The wheel assembly having a hawsepipe, rotationally mounted in that end of the main shaft that is remote from the spigot, but which is axially fixed in position, such hawsepipe anchoring sliding members that slide in the second cylinder and constrain the second cylinder to retain a fixed rotary relationship with the hawsepipe and such hawsepipe being threaded by one or a plurality of fine wire ropes and serving to bend the rope or ropes through approximately a right angle.

The wheel assembly having a second compression spring, acting between the hawsepipe and the second cylinder, such spring tending to push the second cylinder and thus the first cylinder, the crossed keys and the epicyclic gearbox towards the spigot.

In an embodiment, pulleys are provided to lead one or a plurality of fine wire ropes from a mooring point on the second cylinder via a hawsepipe and thence to a remote mechanism whose function is to pull the rope or ropes, against the second compression spring, to one definite position selected from a plurality of such selectable positions, each position corresponding to a definite station of the gearbox on the main shaft and consequently a selected gear ratio.

In an embodiment, a wheel hub, is rotationally mounted to the end of the main shaft closest to the spigot, a plurality of spokes extending radially from this hub to the rim of a road wheel and where a driven dog clutch is concentrically affixed to the hub, on the side of the hub remote from the spigot, such driven dog clutch having identical dentation to the clutches associated with the epicyclic gearbox and having its teeth pointing inward.

In an embodiment, a driving dog clutch with identical dentation to those associated with the epicyclic gearbox is concentrically and fixedly attached to the first brake drum, with its teeth pointing inward.

In an embodiment, the driving and the driven dog clutch are separated axially by a fixed distance, such distance being so chosen that, as the epicyclic gearbox moves axially on the main shaft, the driving and driven dog clutches can engage selectively with one or two neighbouring clutches of the three clutches associated with the gearbox and thereby select one of the three possible ratios of the gearbox.

In an embodiment, the spaces between the three dog clutches of the epicyclic gearbox and the spacing between the driving and driven dog clutch are such that between each axial location of the gearbox corresponding to a selectable gear ratio, there is a station where not more than one dog clutch of the gearbox is engaged, thus producing a “neutral” between gear ratios and preventing the system from locking up.

The wheel assembly having a structure, termed an “oscillator” that can rotate or oscillate about the main shaft and is composed in essence of two circular plates, separated by rigid separation members, and bolted together so that it forms a rigid structure, a “near” plate being closest to the spigot and a “far” plate being furthest.

In an embodiment, cam followers are rotatably and adjustably mounted on one or both plates so that they can run on runways on the periphery of one or both brake drums.

In an embodiment, one or both of the brake drums has a concentric bevel that can mate with a Vee'ed cam follower, rotatably attached to the near or far plate, thus providing axial location of the oscillator on the main shaft.

In an embodiment, the cam followers that serve to force the wedges against the brake drums, are rotatably mounted to the rigid separation members associated with the oscillator so that, when a wedge, either on the near or far brake drum jams, the rotation of the oscillator will transmit a torque to this brake drum.

In an embodiment, one or several locking arms are pivotally mounted at one of their ends to the first plate and whose other end is receivable into the driven dog clutch, attached to the wheel hub, in such a way that when the locking arm is received into the driven clutch, the driven clutch and the first plate are irrotationally locked together.

In an embodiment, the locking arms are impelled by springs to lock into the driven dog clutch but can be withdrawn from such engagement by pulling on that end not pivotally fixed, by wire ropes or other mechanical or electrical arrangement.

In an embodiment, friction wedges operate on the first brake drum in such a direction that rotation of the oscillator in the direction of forward motion of the wheels jams the wedges and impels torque transfer from the oscillator to the first brake drum and that allows free rotation when the oscillator turns in the opposite direction.

In an embodiment, friction wedges operate on the second brake drum in such a way that rotation of the oscillator in the direction contrary to forward motion of the wheels jams the wedges and impels torque transfer from the oscillator to the second brake drum and allows free rotation in the opposite direction.

In an embodiment, a rigid structure called a control column, is rigidly and radially affixed to the oscillator, and has a control element, mounted to the end remote from the main shaft so that pushing or pulling the control element tends to rotate the oscillator.

In an embodiment, the control element is mounted on a rotatable structure, itself mounted on trunnion pins such that a shaft about which the control element can rotate, can adopt, and be locked into a disposition substantially parallel to the main shaft or to a disposition where its axis lies substantially on a radius extending from the main shaft.

In an embodiment, a cylindrical mode change drum is rotatably mounted to the control column near its inboard end.

In an embodiment, the mode change drum can be impelled to rotate in a first direction when a wire rope or plurality of wire ropes that is attached to the mode change drum is tightened and where a return spring and associated means are provided to bias the mode change drum to rotate in a second, contrary direction.

In an embodiment, changing the disposition of the control element from having its stub axle parallel to the main axis to a disposition where they are orthogonal, causes the mode change drum to rotate, in a first direction and consequently to tension a spring or else, when the control element is returned to the original disposition, to allow the spring to move the mode change drum back to its original condition.

In an embodiment, the inner cables of a plurality of Bowden cables are attached to the drum, running in opposite senses around the mode change drum so that one set of cables is tensioned while the other set is slackened when the drum rotates in either direction.

In an embodiment, the Bowden cables that are connected to the mode change drum are so attached at their other ends to the locking arms, the snubbing mechanism and to the friction wedges that rotation of the mode change drum corresponding to furling the control element causes the wedges operating on the second brake drum to be disabled and causes the locking arm to lock the oscillator to the driven dog clutch.

In an embodiment, the Bowden cables that are connected to the mode change drum are so attached at their other ends to the locking arms and to the friction wedges that rotation of the mode change drum corresponding to deploying the control element causes the wedges operating on the second brake drum to be enabled and causes the locking arms to withdraw from the driven dog clutch and enables the snubbing mechanism.

The wheel assembly having a cylindrical “main brake drum” attached concentrically to the wheel hub, such brake drum being provided with a necklace of members, circumferentially joined and having friction material interposed between their inner surfaces and the main brake drum.

In an embodiment, a scissors mechanism is attached to the necklace at it ends, one end to each end of the necklace and further having one leg of the scissors affixed to the near plate and having a Bowden cable so arranged that its operation will tend to close the scissors and so energise the braking effect of the necklace.

In an embodiment, means are provided that, when the wheel assembly is in the second mode (rectified), the handle will only move substantially in the upper half of its gyration but will be able to move from the lower to the upper half, where it becomes trapped, this scheme providing that the handle will never fall out of the reach of the user.

In an embodiment, the means to snub the handle to the upper half of its gyration are provided by a blade, rotationally pivoted on a rigid separating member between the near and far plate of the oscillator and being impelled by a spring to assume a posture where it can bear upon a land on the chain assembly, with means being provided that when the wheel assembly is put into the second mode, the blade is withdrawn against the spring, thus deactivating the snubbing.

In an embodiment, the mode change drum has a wire rope or ropes attached that serve to deactivate the snubbing mechanism when the wheel assembly is in the first mode.

It will be appreciated that the invention broadly consists in the parts, elements and features described in this specification, and is deemed to include any equivalents known in the Art which, if substituted for the described elements and features, would not materially alter the substance of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated feature but not to preclude the presence or addition of further features in various embodiments of the invention.

### LIST OF COMPONENTS

1 wheel assembly
6 wire ropes/cable
7 brake lever
7a capstan
7b slot
7c fastener
9 mounting block (control column)
9a arm
9b trunnion pins
10 road wheel
11 main shaft
11a slots for keys 200
12 spokes
12a spokes
13 wheel rim
14 pushrim
15 spigot
16 attachment bracket (optional)
17 collar
30 control member
32 wheel hub
33 ball bearing
34 driven dog clutch
35 near brake drum
36 bevel brake drum
37 driving dog clutch
38 toroidal cavity
40 gearbox
41 sun gear
41a mating slots of sun gear
42 planet gears
42a spindles for planet gears
42b bearings/bushings for planet gears
43 ring gear
44 intermediate dog clutch
45 outer dog clutch
46 outer dog clutch
47 washer between intermediate and outer clutches
50 fastener
51 cable/wire rope
52 tension spring
55 setscrew
56 friction pads
61 first end plate/near plate
62 second end plate/far plate
63 spacers
64a cam followers
65a cam follower
65b cam follower
66 flat brake drum
66b sectioned face
67 friction wedge
67a friction wedge
67b friction wedge
67d bevelled surface
68 far brake drum
69 stabilizing bearing
71 housing
72a sprocket
72b sprocket
72c sprocket
72d sprocket
72e sprocket
72f sprocket
72g sprocket
72h sprocket
73 first chain
74 second chain
75 aperture
80 mode one pawl
81 nib of mode one pawl 80
82 tension spring
83 fine wire rope
84 mooring boss
91 control column
98 stub shaft
101 first motion shaft
102 bearing
103 handle
104 second motion shaft
105 bearing
106 screw
107 detent arm
108 hardened member with detent slots
109 cylindrical enlargement
110 short peg
111 screw
200 keys
201 first cylinder
203 second cylinder
204 pin
206 second spring
210 shafts
211 bearing
212 ball bearing
213 socket head cap screw
214 spring
216 hawsepipe
217 boss
218 screw
227 magnet
229 locking lever
229a engagement end
229b distal end
230 shaft
231 compression spring
232 land
242 locking member
243 friction disc
244 spring
250 change drum
251 connecting member
252 slug
253 shaft
254 crank
255 spring
256 Bowden cable sheath
257 Bowden cable sheath
258 cable to wedges 67b
259 cable to wedges 67b
260 cable to mode one pawls
261 cable to snubbing mechanism
262 shaft
263a radially projecting engagement member (oscillator)
263b radially projecting engagement member (oscillator)
264a snubbing nib
264b snubbing nib
265 snubbing structure
266 snubbing structure housing
267 snubbing structure blade
501 brake drum
502 brake links
503 friction pads
504 roller chain master links
505a scissor part a
505b scissor part b
506a Bowden cable
506b brake cable
600 oscillator
700 chain assembly

1. A wheel assembly for a wheelchair, the wheel assembly comprising:
a wheel rotatably mounted on a main shaft,
a drive assembly, and
a control member configured to rotate around the main shaft, the radius of rotation of the control member being within the radius of the wheel,
the control member being operably engaged with the wheel via the drive assembly to propel the wheelchair, wherein the control member comprises a control element which can be furled or unfurled, such furling or unfurling changing the operation of the wheel chair between two modes of operation:
a first mode, wherein the wheel always rotates in the same direction that the control member is rotated; and
a second mode, wherein rotation of the control member in a first direction or in an opposite direction is translated into rotation of the wheelchair in a first direction.

2. The wheel assembly of claim 1, wherein unfurling the control element changes the mode of operation of the wheelchair to the second mode.

3. The wheel assembly of claim 1, wherein furling the control element configures the control element such that the axis of the control element lies in a plane that is functionally orthogonal to the axis of rotation of the wheel assembly.

4. The wheel assembly of claim 1, wherein the control element can be unfurled to protrude from the plane of the rotation of the control member, such that the axis of the control element is substantially parallel to the main shaft and can be grasped by a user.

5. The wheel assembly of claim 4, wherein the control element can be locked in the unfurled position.

6. The wheel assembly of claim 1, wherein the control member is a pushrim.

7. The wheel assembly of claim 1, comprising means to limit the rotation of the control member when the wheel assembly is in the second mode, such that the control element remains substantially within an upper half of the wheel assembly but will be able to move from a lower half to the upper half, where the control element becomes trapped, thereby providing that the handle will never fall out of the reach of a user.

8. The wheel assembly of claim 1, wherein the main shaft comprises a spigot attached axially and concentrically, to engage the wheel assembly with a hole in a frame of the wheelchair.

9. The wheel assembly of claim 1, further comprising wedges, positioned between rotary cam followers and brake drums that are rotatably mounted on the main shaft, the wedges being drawn into a pinch point between the cam followers and the brake drums by springs acting between the wedges and a structure supporting the cam follower and being configured to lock rotation between the cam follower and the brake drum, when rotated in one direction and to slide when rotated in the other direction;
wherein the wheel assembly further comprises mechanical or electrical means that engage with the wedge to withdraw the wedge away from the pinch point between brake drum and the cam follower and thereby to disable interaction between cam follower and brake drum; and
wherein the wheel assembly further comprises a first brake drum and a second brake drum, the brake drums rotatably mounted on the main shaft and configured to be rotationally impelled by wedges that can be induced to jam in pinch points between the cam followers and the brake drums.

10. (canceled)

11. (canceled)

12. (canceled)

13. (canceled)

14. The wheel assembly of claim 9, comprising a contra-rotation mechanism that causes any rotation of the first brake drum in any direction to cause rotation of the second brake drum in the contrary direction and any rotation of the second brake drum in any direction to cause rotation of the first brake drum in a contrary direction.

15. (canceled)

16. The wheel assembly of claim 14, comprising an epicyclic gearbox comprising a sun gear, a plurality of planet gears and a ring gear, the gearbox being positioned concentrically about the main shaft and being slidable on the main shaft such that the rotation of the control member can be transmitted to the wheel at a plurality of gear ratios.

17. The wheel assembly of claim 16, wherein crossed keys are inserted diametrically and slidably into slots in the main shaft, to extend on either side of the main shaft and to engage in slots in the inner surface of the sun gear, each key comprising protrusions so that, when the crossed keys are nested the protrusions will press on either side of the sun gear;
wherein the crossed keys are securely attached to a member, in a preferred arrangement, a first cylinder that is a sliding fit in the main shaft, the assemblage ensuring that the sun gear can move irrotationally along the axis of the main shaft but is at all times substantially orthogonal to the main shaft;
wherein the wheel assembly further comprises a second cylinder that is concentric with the first cylinder and slides in the main shaft on the side of the first cylinder away from the spigot and that can be drawn away from the first cylinder against a first spring within the first cylinder, can rotate freely with respect to the first cylinder but cannot be moved closer to the first cylinder than its quiescent position where it is almost touching the first cylinder, the second cylinder offering an anchor point to attach one or a plurality of fine wire ropes to it; and
wherein the wheel assembly optionally comprises a second compression spring, acting against the second cylinder, the spring tending to push the second cylinder and thus the first cylinder, the crossed keys and the epicyclic gearbox towards the spigot.

18. (canceled)

19. (canceled)

20. (canceled)

21. (canceled)

22. The wheel assembly of claim 12, wherein a wheel hub is rotationally mounted to the end of the main shaft closest to the spigot, a plurality of spokes extending radially from this hub to the rim of a road wheel and wherein a driven dog clutch is concentrically affixed to the hub, on the side of the hub remote from the spigot, the driven dog clutch engaging with dog clutches associated with the epicyclic gearbox and being driven by the epicyclic gearbox.

23. The wheel assembly of claim 22, comprising a structure, termed an “oscillator” that can rotate or oscillate about the main shaft, comprising a first circular plate and a second circular plate, separated by rigid separation members, and bolted together so that it forms a rigid structure.

24. (canceled)

25. (canceled)

26. (canceled)

27. A wheelchair comprising the wheel assembly of claim 1.
